(19) United States
(12) Patent Application Publication
(10) Pub. No.: US 2008/0193796 A1
(43) Pub. Date: Aug. 14, 2008

(54) ORGANIC ELECTROLUMINESCENT DEVICE

(75) Inventors: Takashi Arakane, Sodegaura-shi (JP); Kenichi Fukuoka, Sodegaura-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Idemitsu Kosan Co., Ltd., Chiyoda-ku (JP)

(21) Appl. No.: 11/943,309

(22) Filed: Nov. 20, 2007

(30) Foreign Application Priority Data
Nov. 20, 2006 (JP) 2006-312817

(51) Int. Cl. H01J 1/62

(52) U.S. Cl. 428/690

(57) ABSTRACT

An organic electroluminescent device including: an anode, a cathode, and at least an emitting layer, an electron-transporting layer and an electron-injecting layer interposed between the anode and the cathode; the emitting layer containing a host material which is a pyrene derivative, a chrysene derivative, a fluorene derivative or an anthracene derivative; the electron-transporting layer containing an electron-transporting material which is a pyrene derivative, a chrysene derivative, a fluorene derivative or an anthracene derivative, the anthracene derivative containing no heterocyclic ring, and has a heterocyclic ring and having a fluorescence quantum yield which is smaller than that of the host material contained in the emitting layer; and the electron-injecting layer containing a non-complex compound having a nitrogen-containing five-membered heterocyclic structure.

### TECHNICAL FIELD

The invention relates to an organic electroluminescent (EL) device. More particularly, the invention relates to an organic EL device having a long life and capable of obtaining a high luminous efficiency.

### BACKGROUND

An organic EL device is a self-emission device utilizing the principle that a fluorescent compound emits light by the recombination energy of holes injected from an anode and electrons injected from a cathode when an electric field is impressed.

For example, Patent Document 1 proposes the use of a hole-blocking layer in order to improve efficiency. However, if the band gap of an emitting layer is large as in the case of blue emission, the ionization potential of the emitting layer is inevitably large. Therefore, the ionization potential of the hole-blocking layer to be combined with the emitting layer has to be larger than that of the emitting layer. As a result, selection of materials is difficult, and the device life is too short to be put into practical use.

Recently, studies have been made on a device having a structure in which two or more electron-injecting and transporting layers are provided. For example, to increase re-combination efficiency, Patent Document 2 discloses a device in which a hole-blocking layer formed of a distyrylarylene derivative, of which the ionization potential is larger than that of the emitting layer by 0.2 eV or more, is provided in contact with an emitting layer. Luminous efficiency improves due to the provision of such a layer.

In order to improve electron mobility, decrease hole mobility, and effectively confine holes in an emitting layer, Patent Document 3 discloses a device in which a mixed ligand complex, a binuclear metal complex, a compound having at least one 1,2,4-triazole ring or a styryl compound material, of which the ionization potential is larger than that of an emitting layer by 0.2 eV or more, is used in a hole-blocking layer.

Patent Document 4 discloses a device in which a compound formed of a carbazolyl group and a phenylene group is used as a material for use in a hole-blocking layer.

With the aim of obtaining a device with a high efficiency and a long life, Patent Document 5 discloses a red-emitting device obtained by stacking an electron-transporting layer formed of a naphthacene derivative or an anthracene derivative, which has high electron-transporting properties and an ionization potential differing from that of the emitting layer by 0.1 eV or less and an electron-injecting layer formed of phenanthroline or phenanthroline derivative. In this device, by restricting the dipole moments of the electron-transporting material and the host material, holes are prevented from flowing out to the electron-transporting layer, and production of excitons in the electron-transporting layer is minimized, whereby emission in the electron-transporting layer is suppressed.

Patent Document 6 discloses a blue-emitting device in which an electron injection-inhibiting layer is inserted between an emitting layer and an electron-transporting layer.

Patent Document 7 discloses a blue-emitting device in which, between an emitting layer and an electron-transporting layer, a non-hole blocking buffer layer formed of an anthracene derivative which has the same ionization potential and electron affinity as those of the host material in the emitting layer is inserted.

Patent Document 8 discloses a device in which an anthracene derivative is used in an electron-transporting layer.

However, none of these conventional devices is practically sufficient in respect of life, driving voltage, and luminous efficiency. Furthermore, optimum combination of an electron-transporting layer and an electron-injecting layer realizing practical device performance has not been found yet.

[Patent document 1] JP-A-2-195683

[Patent document 2] JP-A-11-242996

[Patent document 3] JP-A-11-329734

[Patent document 4] JP-A-2003-31371

[Patent document 5] JP-A-2003-338377

[Patent document 6] JP-A-2004-362914

[Patent document 7] US-A1-2005-0064235

[Patent document 8] JP-T-2006-518545

An object of the invention is to provide an organic EL device which has a high efficiency and a long life.

### SUMMARY OF THE INVENTION

According to the invention, the following organic EL device is provided.

1. An organic electroluminescent device comprising:

an anode,

a cathode, and

at least an emitting layer, an electron-transporting layer and an electron-injecting layer interposed between the anode and the cathode;

the emitting layer containing a host material which is a pyrene derivative, a chrysene derivative, a fluorene derivative or an anthracene derivative; the electron-transporting layer containing an electron-transporting material which is a pyrene derivative, a chrysene derivative, a fluorene derivative or an anthracene derivative, the anthracene derivative containing no heterocyclic ring, and has a fluorescence quantum yield which is smaller than that of the host material contained in the emitting layer; and

the electron-injecting layer containing a non-complex compound having a nitrogen-containing five-membered heterocyclic structure.

2. The organic electroluminescent device according to 1, wherein the fluorescence quantum yield of the host material contained in the emitting layer is 0.15 to 1, and the fluorescence quantum yield of the electron-transporting material contained in the electron-transporting layer is 0.1 to 0.2.
3. The organic electroluminescent device according to 1 or 2, wherein the electron-transporting material of the electron-transporting layer is an aromatic compound represented by the following formula (1), excluding 2-(1,1-dimethylethyl)-9,10-bis(2-naphthalenyl)anthracene and 9,10-di-(2-naphthyl)anthracene:

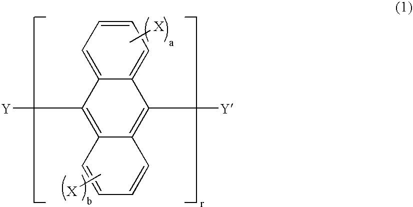

wherein Y and Y′ are independently a substituted or unsubstituted aryl group having 5 to 60 nucleus atoms;

X is independently a substituted or unsubstituted aryl group having 6 to 50 nucleus carbon atoms, a substituted or unsubstituted alkyl group having 1 to 50 carbon atoms, a substituted or unsubstituted alkoxy group having 1 to 50 carbon atoms, a substituted or unsubstituted aralkyl group having 6 to 50 carbon atoms, a substituted or unsubstituted aryloxy group having 5 to 50 nucleus atoms, a substituted or unsubstituted arylthio group having 5 to 50 nucleus atoms, a substituted or unsubstituted alkoxycarbonyl group having 1 to 50 carbon atoms, a carboxyl group, a halogen atom, a cyano group, a nitro group, or a hydroxyl group;

a and b are each an integer of 0 to 4;

r is an integer of 1 to 3; and when r, a or b is plural, Xs may be the same or different.

4. The organic electroluminescent device according to 1 or 2, wherein the electron-transporting material of the electron-transporting layer is an aromatic compound represented by the following formula (2):

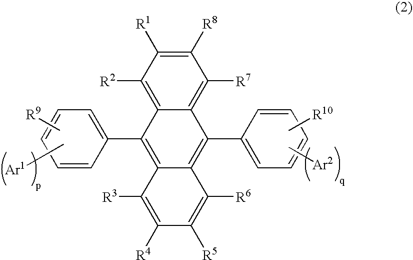

wherein Ar¹ and Ar² are independently a substituted or unsubstituted aryl group having 6 to 50 nucleus carbon atoms;

p and q are each an integer of 1 to 4; when p or q is plural, Ar¹s or Ar²s may be the same or different; and

R¹ to R¹⁰ are independently a hydrogen atom, a substituted or unsubstituted alkyl group having 1 to 50 carbon atoms, a substituted or unsubstituted aryl group having 6 to 50 nucleus carbon atoms, a substituted or unsubstituted cycloalkyl group, a substituted or unsubstituted alkoxy group having 1 to 50 carbon atoms, a substituted or unsubstituted aralkyl group having 6 to 50 carbon atoms, a substituted or unsubstituted aryloxy group having 5 to 50 nucleus atoms, a substituted or unsubstituted arylthio group having 5 to 50 nucleus atom, a substituted or unsubstituted alkoxycarbonyl group having 1 to 50 carbon atoms, a substituted or unsubstituted silyl group, a carboxyl group, a halogen atom, a cyano group, a nitro group, or a hydroxyl group.

5. The organic electroluminescent device according to 1 or 2, wherein the electron-transporting material of the electron-transporting layer is an aromatic compound represented by the following formula (3), excluding 2-(1,1-dimethylethyl)-9,10-bis(2-naphthalenyl)anthracene and 9,10-di-(2-naphthyl)anthracene:

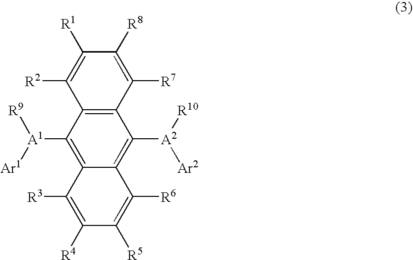

wherein A¹ and A² are independently a substituted or unsubstituted condensed aromatic ring group having 10 to 20 nucleus carbon atoms;

Ar¹ and Ar² are independently a hydrogen atom or a substituted or unsubstituted aryl group having 6 to 50 nucleus carbon atoms;

R¹ to R¹⁰ are independently a hydrogen atom, a substituted or unsubstituted aryl group having 6 to 50 nucleus carbon atoms, a substituted or unsubstituted alkyl group having 1 to 50 carbon atoms, a substituted or unsubstituted cycloalkyl group, a substituted or unsubstituted alkoxy group having 1 to 50 carbon atoms, a substituted or unsubstituted aralkyl group having 6 to 50 carbon atoms, a substituted or unsubstituted aryloxy group having 5 to 50 nucleus atoms, a substituted or unsubstituted arylthio group having 5 to 50 nucleus atoms, a substituted or unsubstituted alkoxycarbonyl group having 1 to 50 carbon atoms, a substituted or unsubstituted silyl group, a carboxyl group, a halogen atom, a cyano group, a nitro group or a hydroxyl group; and

adjacent groups of Ar¹, Ar², R⁹ and R¹⁰ may form a saturated or unsaturated cyclic structure.

6. The organic electroluminescent device according to 1 or 2, wherein the electron-transporting material of the electron-transporting layer is an aromatic compound represented by the following formula (4):

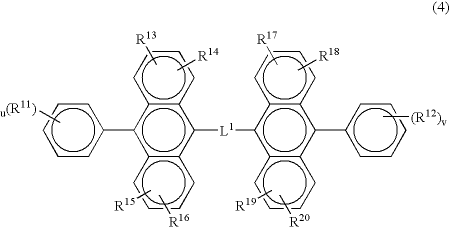

wherein R¹¹ to R²⁰ are independently a hydrogen atom, an alkyl group, a cycloalkyl group, a substituted or unsubstituted aryl group, an alkoxyl group, an aryloxy group, an alkylamino group, an alkenyl group or an arylamino group;

u and v are each an integer of 1 to 5, and when they are 2 or more, R¹¹s or R¹²s may be the same or different and R¹¹s or R¹²s may bond to each other to form a ring;

R¹³ and R¹⁴, R¹⁵ and R¹⁶, R¹⁷ and R¹⁸, R¹⁹ and R²⁰ may bond to each other to form a ring; and

L¹ is a single bond, —O—, —S—, —N(R)— (R is an alkyl group or a substituted or unsubstituted aryl group), an alkylene group or an arylene group.

7. The organic electroluminescent device according to 1 or 2, wherein the electron-transporting material of the electron-transporting layer is an aromatic compound represented by the following formula (5):

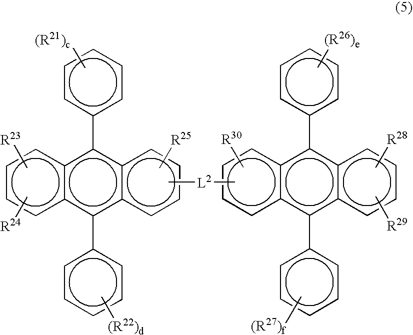

wherein R²¹ to R³⁰ are independently a hydrogen atom, an alkyl group, a cycloalkyl group, an aryl group, an alkoxyl group, an aryloxy group, an alkylamino group, an arylamino group or a substituted or unsubstituted heterocyclic group;

c, d, e and f are each an integer of 1 to 5, and when they are 2 or more, R²¹s, R²²s, R²⁶s or R²⁷s may be the same or different and R²¹s, R²²s, R²⁶s or R²⁷s may bond to each other to form a ring;

R²³ and R²⁴, and R²⁸ and R²⁹ may bond to each other to form a ring; and

L² is a single bond, —O—, —S—, —N(R)— (R is an alkyl group or a substituted or unsubstituted aryl group), an alkylene group, or an arylene group.

8. The organic electroluminescent device according to 1 or 2, wherein the electron-transporting material of the electron-transporting layer is an aromatic compound represented by the following formula (6):

(A³)q—(X¹)h-(Ar¹¹)i-(Y¹)j-(B¹)k (6)

wherein X¹ is independently a substituted or unsubstituted pyrene residue;

A³ and B¹ are independently a hydrogen atom, a substituted or unsubstituted aromatic hydrocarbon group having 3 to 50 nucleus carbon atoms, a substituted or unsubstituted aromatic heterocyclic group having 1 to 50 nucleus carbon atoms, a substituted or unsubstituted alkyl group or alkylene group having 1 to 50 carbon atoms or a substituted or unsubstituted alkenyl group or alkenylene group having 1 to 50 carbon atoms;

Ar¹¹ is independently a substituted or unsubstituted aromatic hydrocarbon group having 3 to 50 nucleus carbon atoms or a substituted or unsubstituted aromatic heterocyclic group having 1 to 50 nucleus carbon atoms;

Y¹ is independently a substituted or unsubstituted aryl group;

h is an integer of 1 to 3, q and k are each an integer of 0 to 4, j is an integer of 0 to 3, and i is an integer of 1 to 5.

9. The organic electroluminescent device according to 1 or 2, wherein the electron-transporting material of the electron-transporting layer is an aromatic compound represented by the following formula (7):

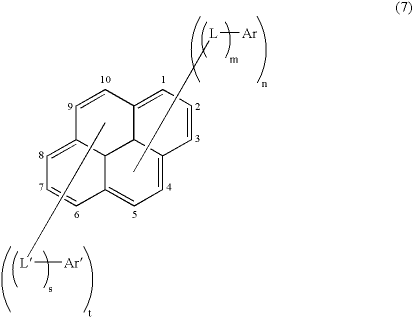

wherein Ar and Ar′ are independently a substituted or unsubstituted aryl group having 6 to 50 nucleus carbon atoms;

L and L′ are independently a substituted or unsubstituted phenylene group, a substituted or unsubstituted naphthalenylene group, a substituted or unsubstituted fluorenylene group or a substituted or unsubstituted dibenzosilolylene group;

m is an integer of 0 to 2, n is an integer of 1 to 4, s is an integer of 0 to 2, t is an integer of 0 to 4, and when m, n, s or t is plural, Ars, Ar's, Ls or L's may be the same or different; and

L or Ar bonds to any position of 1 to 5 of the pyrene, and L′ or Ar′ bonds to any position of 6 to 10 of the pyrene.

10. The organic electroluminescent device according to 1 or 2,
wherein the electron-transporting material of the electron-transporting layer is an aromatic compound represented by the following formula (8):

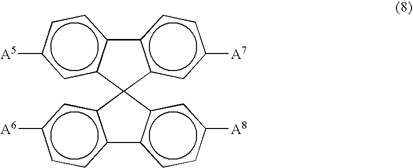

wherein A⁵ to A⁸ are independently a substituted or unsubstituted biphenyl group or a substituted or unsubstituted naphthyl group.
11. The organic electroluminescent device according to 1 or 2, wherein the electron-transporting material of the electron-transporting layer is an aromatic compound represented by the following formula (9):

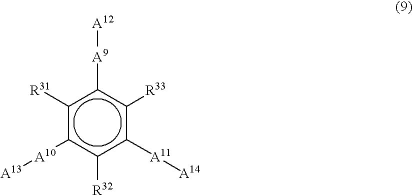

wherein A⁹ to A¹¹ are independently a substituted or unsubstituted arylene group having 6 to 50 nucleus carbon atoms; A¹² to A¹⁴ are independently a hydrogen atom, a substituted or unsubstituted aryl group having 6 to 50 nucleus carbon atoms; R³¹ to R³³ are independently a hydrogen atom, an alkyl group having 1 to 6 carbon atoms, a cycloalkyl group having 3 to 6 carbon atoms, an alkoxyl group having 1 to 6 carbon atoms, an aryloxy group having 5 to 18 carbon atoms, an aralkyloxy group having 7 to 18 carbon atoms, an arylamino group having 5 to 16 carbon atoms, a nitro group, a cyano group, an ester group having 1 to 6 carbon atoms or a halogen atom; and at least one of A⁹ to A¹⁴ is a group having 3 or more condensed aromatic rings.
12. The organic electroluminescent device according to 1 or 2, wherein the electron-transporting material of the electron-transporting layer is an aromatic compound represented by the following formula (10):

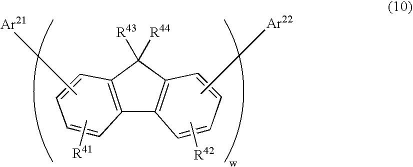

wherein R⁴¹ and R⁴² are a hydrogen atom, a substituted or unsubstituted alkyl group, a substituted or unsubstituted aralkyl group, a substituted or unsubstituted aryl group, a substituted or unsubstituted heterocyclic group, a substituted amino group, a cyano group or a halogen atom; R⁴¹ and R⁴² bonding to different fluorene groups may be the same or different; R⁴¹ and R⁴² bonding to the same fluorene group may be the same or different;

R⁴³ and R⁴⁴ are independently a hydrogen atom, a substituted or unsubstituted alkyl group, a substituted or unsubstituted aralkyl group, a substituted or unsubstituted aryl group or a substituted or unsubstituted heterocyclic group; R⁴³ and R⁴⁴ bonding to different fluorene groups may be the same or different; R⁴³ and R⁴⁴ bonding to the same fluorene group may be the same or different;

Ar²¹ and Ar²² are independently a substituted or unsubstituted condensed polycyclic aryl group having 3 or more benzene rings in total or a substituted or unsubstituted condensed polycyclic heterocyclic group having 3 or more benzene rings and heterocyclic rings in total and bonding to the fluorene group through a carbon atom; Ar²¹ and Ar²² may be the same or different; and

w is an integer of 1 to 10; when w is plural, R⁴¹s, R⁴²s, R⁴³s or R⁴⁴s may be the same or different.

13. The organic electroluminescent device according to any one of 1 to 12, wherein the compound which contains a nitrogen-containing five-membered heterocyclic structure of the electron-injecting layer is a compound represented by the following formula (12):

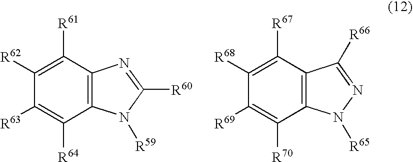

wherein R⁵⁹ to R⁷⁰ are independently a hydrogen atom, a substituted or unsubstituted aryl group having 5 to 60 nucleus atoms, a substituted or unsubstituted heteroaryl group having 5 to 60 nucleus atoms, a substituted or unsubstituted alkyl group having 1 to 50 carbon atoms, a substituted or unsubstituted cycloalkyl group having 3 to 50 carbon atoms, a substituted or unsubstituted aralkyl group having 6 to 50 nucleus atoms, a substituted or unsubstituted alkoxy group having 1 to 50 carbon atoms, a substituted or unsubstituted aryloxy group having 5 to 50 nucleus atoms, a substituted or unsubstituted arylthio group having 5 to 50 nucleus atom, a substituted or unsubstituted alkoxycarbonyl group having 1 to 50 carbon atoms, an amino group substituted with a substituted or unsubstituted aryl group having 5 to 50 nucleus atoms, a halogen atom, a cyano group, a nitro group, a hydroxyl group, or a carboxyl group; adjacent groups of R⁵⁹ to R⁷⁰ may bond to each other to form an aromatic ring; and at least one of R⁵⁹ to R⁷⁰ is a substituent represented by the following formula:

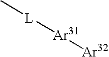

wherein L is a substituted or unsubstituted arylene group having 6 to 60 carbon atoms, a substituted or unsubstituted heteroarylene group having 5 to 60 carbon atoms or a substituted or unsubstituted fluorenylene group;

Ar³¹ is a substituted or unsubstituted arylene group having 6 to 60 carbon atoms, a substituted or unsubstituted pyridinylene group or a substituted or unsubstituted quinolinylene group;

Ar³² is a hydrogen atom, a substituted or unsubstituted aryl group having 5 to 60 nucleus atoms, a substituted or unsubstituted pyridyl group, a substituted or unsubstituted quinolyl group, a substituted or unsubstituted alkyl group having 1 to 50 carbon atoms, a substituted or unsubstituted cycloalkyl group having 3 to 50 carbon atoms, a substituted or unsubstituted aralkyl group having 6 to 50 nucleus atoms, a substituted or unsubstituted alkoxy group having 1 to 50 carbon atoms, a substituted or unsubstituted aryloxy group having 5 to 50 nucleus atoms, a substituted or unsubstituted arylthio group having 5 to 50 nucleus atoms, a substituted or unsubstituted alkoxycarbonyl group having 1 to 50 carbon atoms, an amino group substituted with a substituted or unsubstituted aryl group having 5 to 50 nucleus atoms, a halogen atom, a cyano group, a nitro group, a hydroxyl group or a carboxyl group.

14. The organic electroluminescent device according to 13, wherein the compound which contains a nitrogen-containing five-membered heterocyclic structure of the electron-injecting layer is a compound represented by the following formula:

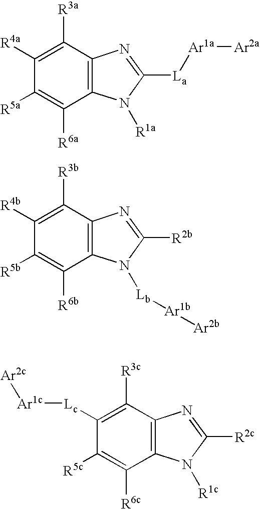

wherein R^{1a} to R^{5c}, Lₐ to L_{c}, and Ar^{1a} to Ar^{2c} are the same as R⁵⁹ to R⁷⁰, L, Ar³¹ and Ar³² in the above formula (12), respectively.

In the device configuration described in Patent Documents 1 to 8, holes which reach the electron-transporting layer cause carrier recombination in the electron-transporting layer. However, the materials which have heretofore been used in the electron-transporting layer tend to deteriorate due to carrier recombination. Such deterioration results in a shorter device life. In the invention, an organic EL device having a long life, a low driving voltage, and a high efficiency can be obtained by selecting suitable compounds and the combination thereof as the material for an electron-injecting layer and an electron-transporting layer.

That is, an organic EL device having a long life can be obtained by using, in the electron-transporting layer which is in contact with the emitting layer, an aromatic compound which minimizes deterioration caused by carrier recombination and suppresses emission of the electron-transporting layer due to its lower fluorescence quantum yield than that of the host material contained in the emitting layer.

On the other hand, a low-driving organic EL device which can readily inject electrons from the cathode can be obtained by using a compound which contains a nitrogen-containing five-membered heterocyclic structure in the electron-injecting layer.

Furthermore, in the invention, since the hole-blocking properties of the electron-transporting layer are not utilized, an organic EL device with a long life and a high efficiency can be obtained irrespective of difference in ionization potential between the host material and the electron-transporting material. In view of the above, an organic EL device with a high efficiency and a long life can be provided by the invention.

### BRIEF DESCRIPTION OF DRAWINGS

FIG. 1 is a schematic cross-sectional view showing one embodiment of the organic EL device according to the invention.

### BEST MODE FOR CARRYING OUT THE INVENTION

The organic EL device of the invention has at least an emitting layer, an electron-transporting layer and an electron-injecting layer between the cathode and the anode. The emitting layer contains a host material which is a pyrene derivative, a chrysene derivative, a fluorene derivative or an anthracene derivative. The electron-transporting layer contains an electron-transporting material which is a pyrene derivative, a chrysene derivative, a fluorene derivative or an anthracene derivative, the anthracene derivative containing no heterocyclic ring, and has a fluorescence quantum yield which is smaller than that of the host material contained in the emitting layer. The electron-injecting layer contains a non-complex compound which has a nitrogen-containing five-membered heterocyclic structure.

One example of the device of the invention will be explained with reference to the drawings.

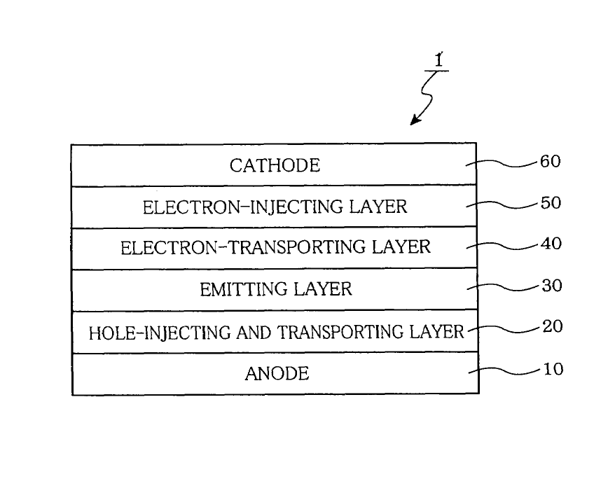

FIG. 1 is a schematic cross-sectional view showing an example of the organic EL device according to the invention.

In the emitting device 1, an anode 10, a hole-injecting and transporting layer 20, an emitting layer 30, an electron-transporting layer 40, an electron-injecting layer 50, and a cathode 60 are stacked on a substrate (not shown) in this order.

In the invention, the emitting layer 30 contains a host material which is a pyrene derivative, a chrysene derivative, a fluorene derivative or an anthracene derivative. The electron-transporting layer 40 contains an electron-transporting material which is a pyrene derivative, a chrysene derivative, a fluorene derivative or an anthracene derivative, the anthracene derivative containing no heterocyclic ring, and has a fluorescence quantum yield which is smaller than that of the host material contained in the emitting layer. The electron-injecting layer 50 contains a non-complex compound having a nitrogen-containing five-membered heterocyclic structure.

In the device configuration of the invention, the emitting layer contains a specific host material, the electron-transporting layer contains a specific electron-transporting material, and the electron-injecting layer contains a specific compound which has a specific nitrogen-containing five-membered heterocyclic structure. The electron-transporting material of the electron-transporting layer has a fluorescence quantum yield which is invariably smaller than that of the host material of the emitting layer. Therefore, there is no case where the host material and the electron-transporting material are totally identical.

By this configuration, injection of holes to the electron-injecting layer is suppressed as compared with the conventional configuration. As a result, an organic EL device having a high efficiency and a low voltage can be obtained. For the same reason, the life of the device can be prolonged.

In the invention, the fluorescence quantum yield of the host material contained in the emitting layer is preferably 0.15 to 1, and the fluorescence quantum yield of the electron-transporting material of the electron-transporting layer is preferably 0.1 to 0.2. It is more preferred that the fluorescence quantum yield of the host material contained in the emitting layer be 0.2 to 1, and the fluorescence quantum yield of the electron-transporting material of the electron-transporting layer be 0.1 to 0.15. By making the fluorescence quantum yield of the electron-transporting material contained in the electron-transporting layer smaller than that of the host material contained in the emitting layer, emission of the electron-transporting layer can be suppressed such that the emission intensity of the emitting layer can be enhanced, whereby the deterioration of the electron-transporting layer can be prevented. As a result, a low-voltage driving organic EL device with a high efficiency and a long life can be obtained. Furthermore, due to the suppression of the emission of the electron-transporting layer, an organic EL device with a high degree of color purity can be obtained.

In the invention, it is preferred that difference in energy gap between the electron-transporting material of the electron-transporting layer and the host material contained in the emitting layer be small. Specifically, such a difference in energy gap is preferably 0.1 eV or less.

It is also preferred that the electron mobility of the electron-transporting material of the electron-transporting layer be high. Specifically, the electron mobility of the electron-transporting material is preferably 10⁻⁴ cm²/V·s or more when a voltage of 10⁴ to 10⁶ V cm is applied.

As a result, emission of the electron-transporting material can be suppressed, and an organic EL device with a high efficiency and a high degree of color purity can be obtained.

The representative structures of the organic EL device of the invention are given below, though the invention is not limited thereto.

(1) Anode/hole-transporting layer/emitting layer/electron-transporting layer/electron-injecting layer/cathode
(2) Anode/hole-injecting layer/hole-transporting layer/emitting layer/electron-transporting layer/electron-injecting layer/cathode
(3) Anode/insulative layer/hole-transporting layer/emitting layer/electron-transporting layer/electron-injecting layer/cathode
(4) Anode/insulative layer/hole-injecting layer/hole-transporting layer/emitting layer/electron-transporting layer/electron-injecting layer/cathode
(5) Anode/hole-transporting layer/emitting layer/electron-transporting layer/electron-injecting layer/insulative layer/cathode
(6) Anode/hole-injecting layer/hole-transporting layer/emitting layer/electron-transporting layer/electron-injecting layer/insulative layer/cathode
(7) Anode/insulative layer/hole-transporting layer/emitting layer/electron-transporting layer/electron-injecting layer/insulative layer/cathode
(8) Anode/insulative layer/hole-injecting layer/hole-transporting layer/emitting layer/electron-transporting layer/electron-injecting layer/insulative layer/cathode

The materials used in the electron-transporting layer, the electron-injecting layer and the emitting layer, which are the characteristic parts of the organic EL device of the invention, will be explained below. Other parts constituting the organic EL device of the invention will be explained later.

### 1. Electron-Transporting Layer

In the invention, the electron-transporting material contains a pyrene derivative, a chrysene derivative, a fluorene derivative or an anthracene derivative, the anthracene derivative containing no heterocyclic ring, and has a fluorescence quantum yield which is smaller than that of the host material contained in the emitting layer. Specific examples of such a derivative include aromatic compounds represented by the following formulas (1) to (10).

An aromatic compound represented by the following formula (1), excluding 2-(1,1-dimethylethyl)-9,10-bis(2-naphthalenyl)anthracene and 9,10-di-(2-naphthyl)anthracene:

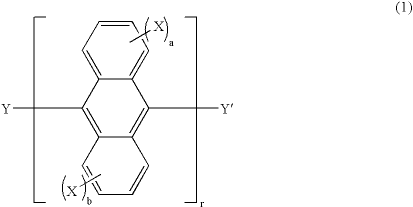

wherein Y and Y′ are independently a substituted or unsubstituted aryl group having 5 to 60 nucleus atoms;

X is independently a substituted or unsubstituted aryl group having 6 to 50 nucleus carbon atoms, a substituted or unsubstituted alkyl group having 1 to 50 carbon atoms, a substituted or unsubstituted alkoxy group having 1 to 50 carbon atoms, a substituted or unsubstituted aralkyl group having 6 to 50 carbon atoms, a substituted or unsubstituted aryloxy group having 5 to 50 nucleus atoms, a substituted or unsubstituted arylthio group having 5 to 50 nucleus atoms, a substituted or unsubstituted alkoxycarbonyl group having 1 to 50 carbon atoms, a carboxyl group, a halogen atom, a cyano group, a nitro group, or a hydroxyl group;

a and b are each an integer of 0 to 4;

r is an integer of 1 to 3; and when r, a or b is plural, Xs may be the same or different.

An aromatic compound represented by the following formula (2):

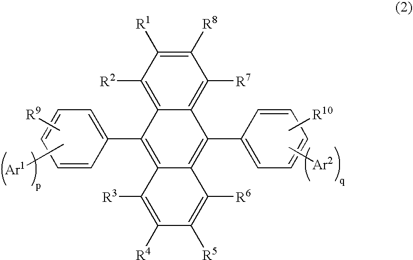

wherein Ar¹ and Ar² are independently a substituted or unsubstituted aryl group having 6 to 50 nucleus carbon atoms;

p and q are each an integer of 1 to 4; when p or q is plural, Ar's or Ar²s may be the same or different; and

R¹ to R¹⁰ are independently a hydrogen atom, a substituted or unsubstituted aryl group having 6 to 50 nucleus carbon atoms, a substituted or unsubstituted alkyl group having 1 to 50 carbon atoms, a substituted or unsubstituted cycloalkyl group, a substituted or unsubstituted alkoxy group having 1 to 50 carbon atoms, a substituted or unsubstituted aralkyl group having 6 to 50 carbon atoms, a substituted or unsubstituted aryloxy group having 5 to 50 nucleus atoms, a substituted or unsubstituted arylthio group having 5 to 50 nucleus atom, a substituted or unsubstituted alkoxycarbonyl group having 1 to 50 carbon atoms, a substituted or unsubstituted silyl group, a carboxyl group, a halogen atom, a cyano group, a nitro group, or a hydroxyl group.

An aromatic compound represented by the following formula (3), excluding 2-(1,1-dimethylethyl)-9,10-bis(2-naphthalenyl)anthracene and 9,10-di-(2-naphthyl)anthracene):

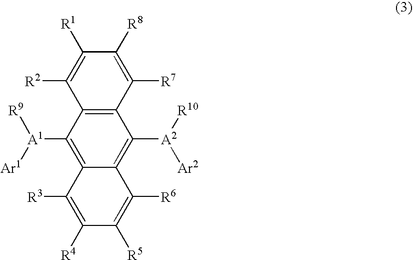

wherein A¹ and A² are independently a substituted or unsubstituted condensed aromatic ring group having 10 to 20 nucleus carbon atoms;

Ar¹ and Ar² are independently a hydrogen atom or a substituted or unsubstituted aryl group having 6 to 50 nucleus carbon atoms;

R¹ to R¹⁰ are independently a hydrogen atom, a substituted or unsubstituted aryl group having 6 to 50 nucleus carbon atoms, a substituted or unsubstituted alkyl group having 1 to 50 carbon atoms, a substituted or unsubstituted cycloalkyl group, a substituted or unsubstituted alkoxy group having 1 to 50 carbon atoms, a substituted or unsubstituted aralkyl group having 6 to 50 carbon atoms, a substituted or unsubstituted aryloxy group having 5 to 50 nucleus atoms, a substituted or unsubstituted arylthio group having 5 to 50 nucleus atoms, a substituted or unsubstituted alkoxycarbonyl group having 1 to 50 carbon atoms, a substituted or unsubstituted silyl group, a carboxyl group, a halogen atom, a cyano group, a nitro group or a hydroxyl group; and

adjacent groups of Ar¹, Ar², R⁹ and R¹⁰ may form a saturated or unsaturated cyclic structure.

An aromatic compound represented by the following formula (4):

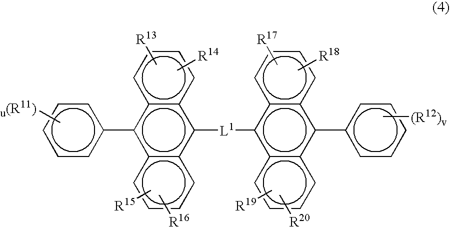

wherein R¹¹ to R²⁰ are independently a hydrogen atom, an alkyl group, a cycloalkyl group, a substituted or unsubstituted aryl group, an alkoxyl group, an aryloxy group, an alkylamino group, an alkenyl group or an arylamino group;

u and v are each an integer of 1 to 5, and when they are 2 or more, R¹s or R²s may be the same or different and R¹s or R²s may bond to each other to form a ring;

R¹³ and R¹⁴, R¹⁵ and R¹⁶, R¹⁷ and R¹⁸, R¹⁹ and R²⁰ may bond to each other to form a ring; and

L¹ is a single bond, —O—, —S—, —N(R)— (R is an alkyl group or a substituted or unsubstituted aryl group), an alkylene group or an arylene group.

An aromatic compound represented by the following formula (5):

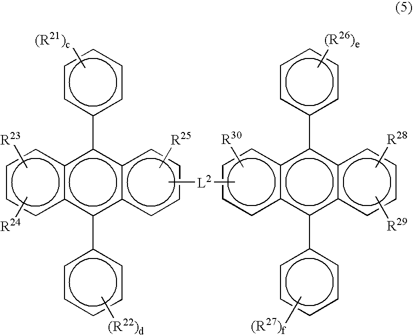

wherein R²¹ to R³⁰ are independently a hydrogen atom, an alkyl group, a cycloalkyl group, an aryl group, an alkoxy group, an aryloxy group, an alkylamino group, an arylamino group or a substituted or unsubstituted heterocyclic group;

c, d, e and f are each an integer of 1 to 5; when they are 2 or more, R²¹s, R²²s, R²⁶s or R²⁷s may be the same or different;

R²¹s, R²²s, R²⁶s or R²⁷s may bond to each other to form a ring;

R²³ and R²⁴, and R²⁸ and R²⁹ may bond to each other to form a ring; and

L² is a single bond, —O—, —S—, —N(R)— (R is an alkyl group or a substituted or unsubstituted aryl group), an alkylene group, or an arylene group.

An aromatic compound represented by the following formula (6):

(A³)q—(X¹)h-(Ar¹¹)i-(Y¹)j-(B¹)k (6)

wherein X¹ is independently a substituted or unsubstituted pyrene residue;

A³ and B¹ are independently a hydrogen atom, a substituted or unsubstituted aromatic hydrocarbon group having 3 to 50 nucleus carbon atoms, a substituted or unsubstituted aromatic heterocyclic group having 1 to 50 nucleus carbon atoms, a substituted or unsubstituted alkyl group or alkylene group having 1 to 50 carbon atoms or a substituted or unsubstituted alkenyl group or alkenylene group having 1 to 50 carbon atoms;

Ar¹¹ is independently a substituted or unsubstituted aromatic hydrocarbon group having 3 to 50 nucleus carbon atoms or a substituted or unsubstituted aromatic heterocyclic group having 1 to 50 nucleus carbon atoms;

Y¹ is independently a substituted or unsubstituted aryl group; and

h is an integer of 1 to 3; q and k are each an integer of 0 to 4; j is an integer of 0 to 3; and i is an integer of 1 to 5.

An aromatic compound represented by the following formula (7):

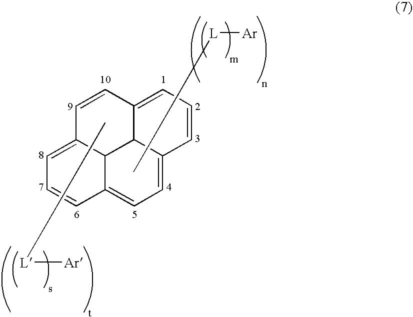

wherein Ar and Ar′ are independently a substituted or unsubstituted aryl group having 6 to 50 nucleus carbon atoms;

L and L′ are independently a substituted or unsubstituted phenylene group, a substituted or unsubstituted naphthalenylene group, a substituted or unsubstituted fluorenylene group, or a substituted or unsubstituted dibenzosilolylene group;

m is an integer of 0 to 2, n is an integer of 1 to 4, s is an integer of 0 to 2, t is an integer of 0 to 4; when m, n, s or t is plural, Ars, Ar's, Ls or L's may be the same or different; and

L or Ar bonds to any position of 1 to 5 of the pyrene, and L′ or Ar′ bonds to any position of 6 to 10 of the pyrene.

An aromatic compound represented by the following formula (8):

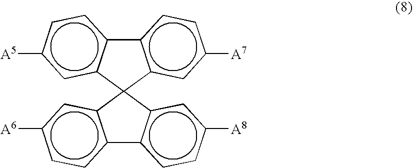

wherein A⁵ to A⁸ are independently a substituted or unsubstituted biphenyl group or a substituted or unsubstituted naphthyl group.

An aromatic compound represented by the following formula (9):

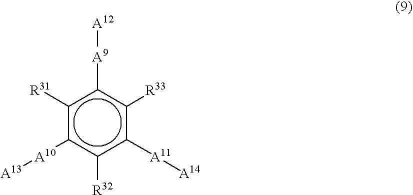

wherein A⁹ to A¹¹ are independently a substituted or unsubstituted arylene group having 6 to 50 nucleus carbon atoms; A¹² to A¹⁴ are independently a hydrogen atom, a substituted or unsubstituted aryl group having 6 to 50 nucleus carbon atoms; R³¹ to R³³ are independently a hydrogen atom, an alkyl group having 1 to 6 carbon atoms, a cycloalkyl group having 3 to 6 carbon atoms, an alkoxyl group having 1 to 6 carbon atoms, an aryloxy group having 5 to 18 carbon atoms, an aralkyloxy group having 7 to 18 carbon atoms, an arylamino group having 5 to 16 carbon atoms, a nitro group, a cyano group, an ester group having 1 to 6 carbon atoms or a halogen atom; and at least one of A⁹ to A¹⁴ is a group having 3 or more condensed aromatic rings.

An aromatic compound represented by the following formula (10):

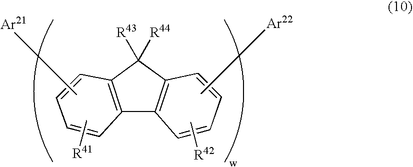

wherein R⁴¹ and R⁴² are a hydrogen atom, a substituted or unsubstituted alkyl group, a substituted or unsubstituted aralkyl group, a substituted or unsubstituted aryl group, a substituted or unsubstituted heterocyclic group, a substituted amino group, a cyano group or a halogen atom; R⁴¹ and R⁴² bonding to different fluorene groups may be the same or different; R⁴¹ and R⁴² bonding to the same fluorene group may be the same or different;

R⁴³ and R⁴⁴ are independently a hydrogen atom, a substituted or unsubstituted alkyl group, a substituted or unsubstituted aralkyl group, a substituted or unsubstituted aryl group or a substituted or unsubstituted heterocyclic group; R⁴³ and R⁴⁴ bonding to different fluorene groups may be the same or different; R⁴³ and R⁴⁴ bonding to the same fluorene group may be the same or different;

Ar²¹ and Ar²² are independently a substituted or unsubstituted condensed polycyclic aryl group having 3 or more benzene rings in total or a substituted or unsubstituted condensed polycyclic heterocyclic group having 3 or more benzene rings and heterocyclic rings in total and bonding to the fluorene group through a carbon atom; Ar²¹ and Ar²² may be the same or different;

w is an integer of 1 to 10; when w is plural, R⁴¹s, R⁴²s, R⁴³s or R⁴⁴s may be the same or different.

As examples of preferable aromatic compounds, an aromatic compound represented by the following formula (11) can also be given.

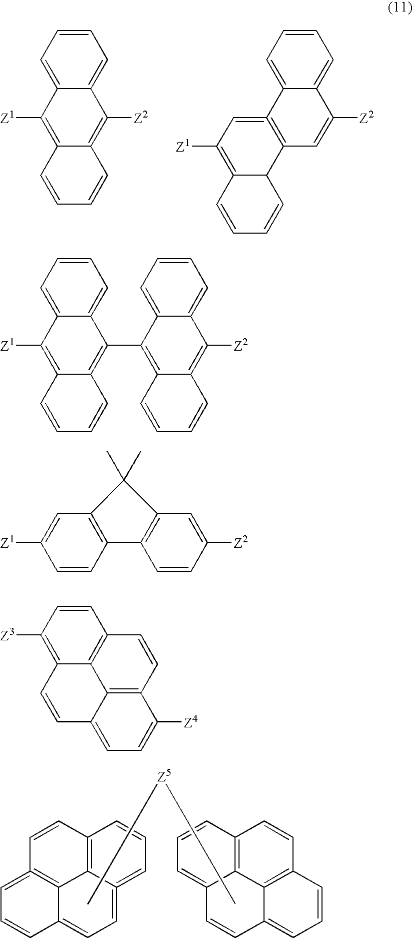

In the formula (11), Z¹ and Z² are independently an aromatic group having 6 to 25 carbon atoms; Z³ and Z⁴ are independently a hydrogen atom or an aromatic group having 6 to 35 carbon atoms. Preferred examples of the aromatic groups represented by Z¹ to Z⁴ include phenyl, biphenyl, terphenyl, naphthyl, phenanthrenyl, pyrenyl, styrenyl, and the combination thereof. Z⁵ is a bivalent group formed of 2 to 5 benzene rings.

### 2. Electron-Injecting Layer

The electron-injecting layer contains a non-complex compound having a nitrogen-containing five-membered heterocyclic structure. Specific examples are the compounds represented by the following formula (12):

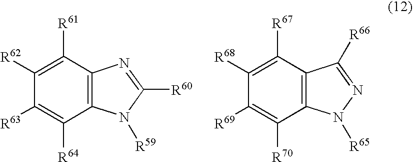

wherein R⁵⁹ to R⁷⁰ are independently a hydrogen atom, a substituted or unsubstituted aryl group having 5 to 60 nucleus atoms, a substituted or unsubstituted heteroaryl group having 5 to 60 nucleus atoms, a substituted or unsubstituted alkyl group having 1 to 50 carbon atoms, a substituted or unsubstituted cycloalkyl group having 3 to 50 carbon atoms, a substituted or unsubstituted aralkyl group having 6 to 50 nucleus atoms, a substituted or unsubstituted alkoxy group having 1 to 50 carbon atoms, a substituted or unsubstituted aryloxy group having 5 to 50 nucleus atoms, a substituted or unsubstituted arylthio group having 5 to 50 nucleus atoms, a substituted or unsubstituted alkoxycarbonyl group having 1 to 50 carbon atoms, an amino group substituted with a substituted or unsubstituted aryl group having 5 to 50 nucleus atoms, a halogen atom, a cyano group, a nitro group, a hydroxyl group, or a carboxyl group; adjacent groups of R⁵⁹ to R⁷⁰ groups may bond to each other to form an aromatic ring; and at least one of R⁵⁹ and R⁷⁰ is a substituent represented by the following formula:

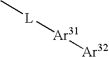

wherein L is a substituted or unsubstituted arylene group having 6 to 60 carbon atoms, a substituted or unsubstituted heteroarylene group having 5 to 60 carbon atoms or a substituted or unsubstituted fluorenylene group;

Ar³¹ is a substituted or unsubstituted arylene group having 6 to 60 carbon atoms, a substituted or unsubstituted pyridinylene group or a substituted or unsubstituted quinolinylene group;

Ar³² is a hydrogen atom, a substituted or unsubstituted aryl group having 5 to 60 nucleus atoms, a substituted or unsubstituted pyridyl group, a substituted or unsubstituted quinolyl group, a substituted or unsubstituted alkyl group having 1 to 50 carbon atoms, a substituted or unsubstituted cycloalkyl group having 3 to 50 carbon atoms, a substituted or unsubstituted aralkyl group having 6 to 50 nucleus atoms, a substituted or unsubstituted alkoxy group having 1 to 50 carbon atoms, a substituted or unsubstituted aryloxy group having 5 to 50 nucleus atoms, a substituted or unsubstituted arylthio group having 5 to 50 nucleus atoms, a substituted or unsubstituted alkoxycarbonyl group having 1 to 50 carbon atoms, an amino group substituted with a substituted or unsubstituted aryl group having 5 to 50 nucleus atoms, a halogen atom, a cyano group, a nitro group, a hydroxyl group or a carboxyl group.

Specific examples of the compounds represented by the formula (12) are given below.

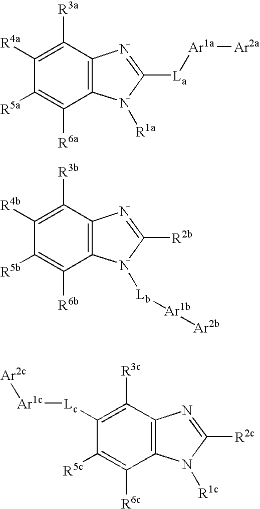

wherein R^{1a} to R^{5c}, Lₐ to L_{c}, and Ar^{1a} to Ar^{2c} are the same as R⁵⁹ to R⁷⁰, L, Ar³¹ and Ar³² in the above formula (12), respectively.

Preferable examples of Lₐ to L_{c} and Ar^{1a} to Ar^{1c} include a substituted or unsubstituted phenylene group, a substituted or unsubstituted biphenylene group, a substituted or unsubstituted naphthylene group, a substituted or unsubstituted anthracenylene group, or a substituted or unsubstituted pyridylene group. More preferable examples include a phenylene group, a phenylene group substituted with a methyl group, a biphenylene group, a naphthylene group, and an anthracenylene group.

Preferable examples of Ar^{2a} to Ar^{2c} include a substituted or unsubstituted phenyl group, a substituted or unsubstituted biphenyl group, a substituted or unsubstituted terphenyl group, a substituted or unsubstituted naphthyl group, and a substituted or unsubstituted aryl group having 6 to 20 carbon atoms. More preferable examples include a phenyl group, a phenyl group substituted with a methyl group, a biphenyl group, a terphenyl group, a naphthyl group and a phenyl group substituted with a naphthyl group.

Preferable examples of R^{1a} and R^{1c} include a substituted or unsubstituted alkyl group having 1 to 6 carbon atoms, and a substituted or unsubstituted aryl group having 6 to 20 carbon atoms. More preferable examples include a methyl group, an ethyl group, a propyl group, a butyl group, a phenyl group, a phenyl group substituted with a methyl group, a biphenyl group and a naphthyl group.

Preferable examples of R^{2b} and R^{2c}, include a hydrogen atom, a substituted or unsubstituted alkyl group having 1 to 6 carbon atoms and a substituted or unsubstituted aryl group having 6 to 20 carbon atoms. More preferable examples of R^{2b} and R^{2c} include a methyl group, an ethyl group, a propyl group, a butyl group, a phenyl group, a phenyl group substituted with a methyl group, a biphenyl group and a naphthyl group.

Preferred examples of R^{3a} to R^{6a}, R^{3b} to R^{6b}, and R^{3c} to R^{6c} include a hydrogen atom, a substituted or unsubstituted alkyl group having 1 to 6 carbon atoms, a substituted or unsubstituted aryl group having 6 to 20 carbon atoms and a cyano group. More preferable examples include a hydrogen atom, a methyl group, a phenyl group, a biphenyl group, a naphthyl group, a cyano group and a trifluoromethyl group.

It is preferred that the thickness of the electron-transporting layer and the electron-injecting layer be 0.1 to 100 nm.

### 3. Emitting Layer

The emitting layer of the organic EL device has the following functions in combination.

(1) Injecting function: function of allowing injection of holes from an anode or a hole-injecting layer and injection of electrons from a cathode or an electron-injecting layer upon application of an electric field
(2) Transporting function: function of moving injected carriers (electrons and holes) due to the force of an electric field
(3) Emitting function: function of allowing electrons and holes to recombine to emit light

Note that electrons and holes may be injected into the emitting layer with different degrees, or the transportation capabilities indicated by the mobility of holes and electrons may differ. It is preferred that the emitting layer move either electrons or holes.

It is preferred that the emitting layer be formed of a host material and a doping material.

In the invention, the host material of the emitting layer is a pyrene derivative, a chrysene derivative, a fluorene derivative or an anthracene derivative and has a fluorescence quantum yield which is larger than that of the electron-transporting material of the electron-transporting layer.

As the host material, the above-mentioned compound represented by the formulas (6) to (10) and (11), which is preferably used in the electron-transporting layer, and has a fluorescence quantum yield of 0.15 to 1, is preferable.

Furthermore, as the host material, a compound which is represented by the following formulas (1′) to (5′), excluding 2-(1,1-dimethylethyl)-9,10-bis(2-naphthalenyl)anthracene and 9,10-di-(2-naphthyl)anthracene, and has a fluorescence quantum yield of 0.15 to 1 is preferable.

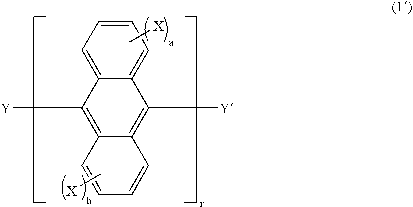

wherein Y and Y′ are independently a substituted or unsubstituted aryl group having 5 to 60 nucleus atoms or a substituted or unsubstituted heteroaryl group having 5 to 60 nucleus atoms.

X is independently a substituted or unsubstituted aryl group having 6 to 50 nucleus carbon atoms, a substituted or unsubstituted heteroaryl group having 5 to 50 nucleus atoms, a substituted or unsubstituted alkyl group having 1 to 50 carbon atoms, a substituted or unsubstituted alkoxy group having 1 to 50 carbon atoms, a substituted or unsubstituted aralkyl group having 6 to 50 carbon atoms, a substituted or unsubstituted aryloxy group having 5 to 50 nucleus atoms, a substituted or unsubstituted arylthio group having 5 to 50 nucleus atoms, a substituted or unsubstituted alkoxycarbonyl group having 1 to 50 carbon atoms, a carboxyl group, a halogen atom, a cyano group, a nitro group, or a hydroxyl group;

a and b are each an integer of 0 to 4;

r is an integer of 1 to 3; and when r, a or b is plural, Xs may be the same or different.

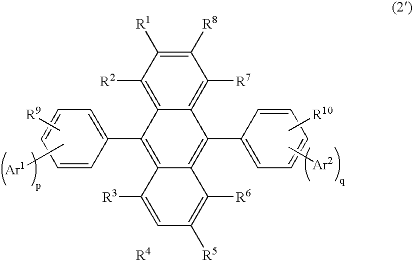

wherein Ar¹ and Ar² are independently a substituted or unsubstituted aryl group having 6 to 50 nucleus carbon atoms and a substituted or unsubstituted heteroaryl group having 5 to 60 nucleus atoms;

p and q are each an integer of 1 to 4; when p or q is plural, Ar¹s or Ar²s may be the same or different; and

R¹ to R¹⁰ are independently a hydrogen atom, a substituted or unsubstituted aryl group having 6 to 50 nucleus carbon atoms, a substituted or unsubstituted heteroaryl group having 5 to 50 nucleus atoms, a substituted or unsubstituted alkyl group having 1 to 50 carbon atoms, a substituted or unsubstituted cycloalkyl group, a substituted or unsubstituted alkoxyl group having 1 to 50 carbon atoms, a substituted or unsubstituted aralkyl group having 6 to 50 carbon atoms, a substituted or unsubstituted aryloxy group having 5 to 50 nucleus atoms, a substituted or unsubstituted arylthio group having 5 to 50 nucleus atom, a substituted or unsubstituted alkoxycarbonyl group having 1 to 50 carbon atoms, a substituted or unsubstituted silyl group, a carboxyl group, a halogen atom, a cyano group, a nitro group, or a hydroxyl group.

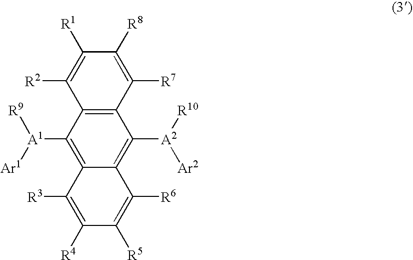

wherein A¹ and A² are independently a substituted or unsubstituted condensed aromatic ring group having 10 to 20 nucleus carbon atoms;

Ar¹ and Ar² are independently a hydrogen atom or a substituted or unsubstituted aryl group having 6 to 50 nucleus carbon atoms;

R¹ to R¹⁰ are independently a hydrogen atom or a substituted or unsubstituted aryl group having 6 to 50 nucleus carbon atoms, a substituted or unsubstituted heteroaryl group having 5 to 50 nucleus atoms, a substituted or unsubstituted alkyl group having 1 to 50 carbon atoms, a substituted or unsubstituted cycloalkyl group, a substituted or unsubstituted alkoxy group having 1 to 50 carbon atoms, a substituted or unsubstituted aralkyl group having 6 to 50 carbon atoms, a substituted or unsubstituted aryloxy group having 5 to 50 nucleus atoms, a substituted or unsubstituted arylthio group having 5 to 50 nucleus atoms, a substituted or unsubstituted alkoxycarbonyl group having 1 to 50 carbon atoms, a substituted or unsubstituted silyl group, a carboxyl group, a halogen atom, a cyano group, a nitro group or a hydroxyl group; and

adjacent groups of Ar¹, Ar², R⁹ and R¹⁰ may form a saturated or unsaturated ring structure.

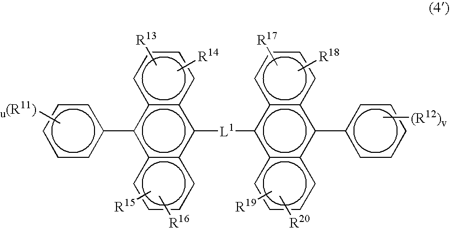

wherein R¹ to R²⁰ are independently a hydrogen atom, an alkyl group, a cycloalkyl group, a substituted or unsubstituted aryl group, an alkoxyl group, an aryloxy group, an alkylamino group, an alkenyl group, an arylamino group or a substituted or unsubstituted heterocyclic group;

u and v are each an integer of 1 to 5, and when they are 2 or more, R¹¹s or R¹²s may be the same or different, and R¹¹s or R¹²s may bond to each other to form a ring;

R¹³ and R¹⁴, R¹⁵ and R¹⁶, R¹⁷ and R¹⁸, R¹⁹ and R²⁰ may bond to each other to form a ring; and

L¹ is a single bond, —O—, —S—, —N(R)— (R is an alkyl group or a substituted or unsubstituted aryl group), an alkylene group or an arylene group.

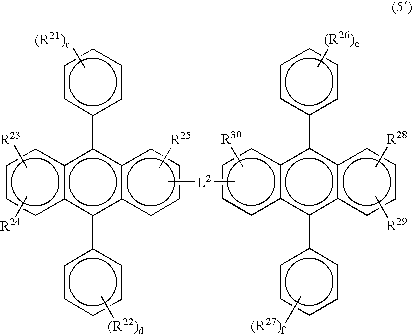

wherein R²¹ to R³⁰ are independently a hydrogen atom, an alkyl group, a cycloalkyl group, an aryl group, an alkoxy group, an aryloxy group, an alkylamino group, an arylamino group, or a substituted or unsubstituted heterocyclic group;

c, d, e and f are each an integer of 1 to 5, and when they are 2 or more, R²¹s, R²²s, R²⁶s or R²⁷s may be the same or different, and R²¹s, R²²s, R²⁶s or R²⁷s may bond to each other to form a ring;

R²³ and R²⁴, and R²⁸ and R²⁹ may bond to each other to form a ring; and

L² is a single bond, —O—, —S—, —N(R)— (R is an alkyl group or a substituted or unsubstituted aryl group), an alkylene group or an arylene group.

Of these host materials, an anthracene derivative, a pyrene derivative, a chrysene derivative, and a fluorene derivative are preferable. A monoanthracene derivative is more preferable, with an asymmetric anthracene derivative being particularly preferable.

These host materials may be used in the emitting layer either alone or in a mixture thereof, or in combination with other known host materials.

Examples of such other known host or doping material include, but not limited to those, an arylamine compound and/or a styrylamine compound, anthracene, naphthalene, phenanthrene, pyrene, tetracene, coronene, chrysene, fluorescein, perylene, phthaloperylene, naphthaloperylene, perynone, phthaloperynone, naphthaloperynone, diphenylbutadiene, tetraphenylbutadiene, coumarin, oxadiazole, aldazine, bisbenzoxazoline, bisstyryl, pyradine, cyclopentadiene, quinoline metal complexes, aminoquinoline metal complexes, benzoquinoline metal complexes, imine, diphenylethylene, vinylanthracene, diaminocarbazole, pyrane, thiopyrane, polymethine, mellocyanine, imidazole chelated oxinoide compounds, quinacridone, rubrene and fluorescent dyes.

It is preferred that the emitting layer contain an arylamine compound and/or a styrylamine compound as a dopant material.

Examples of the arylamine compound include those represented by the following formula (A), and examples of the styrylamine compound represented by the following formula (B) include those represented by the following formula (B):

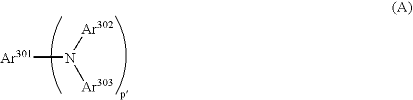

wherein Ar³⁰¹ is a p′-valent group corresponding to phenyl, naphthyl, biphenyl, terphenyl, stilbenzyl or distyrylaryl; Ar³⁰² and Ar³⁰³ are independently a hydrogen atom or a substituted or unsubstituted aromatic group having 6 to 20 carbon atoms; p′ is an integer of 1 to 4; and more preferably, the styryl group of Ar³⁰² and/or Ar³⁰³ is substituted.

As examples of the aromatic group having 6 to 20 carbon atoms, phenyl, naphthyl, anthracenyl, phenanthryl, and terphenyl are preferable.

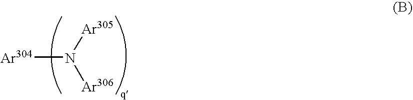

wherein Ar³⁰⁴ is a substituted or unsubstituted aromatic group with a valency of q′ and having 5 to 40 nucleus carbon atoms; Ar³⁰⁵ and Ar³⁰⁶ are independently a substituted or unsubstituted aryl group having 5 to 40 nucleus carbon atoms; and q′ is an integer of 1 to 4.

Examples of the aryl group having 5 to 40 nucleus atoms include phenyl, naphthyl, anthracenyl, phenanthryl, pyrenyl, chrysenyl, cholonyl, biphenyl, terphenyl, pyrrolyl, furanyl, thiophenyl, benzothiophenyl, oxadiazolyl, diphenylanthracenyl, indolyl, carbazolyl, pyridyl, benzoquinolyl, fluoranthenyl, acenaphthofluoranthenyl and stilbene. The aryl group having 5 to 40 nucleus atoms may further be substituted with a substituent. Preferable substituents include an alkyl group having 1 to 6 carbon atoms (e.g. ethyl, methyl, isopropyl, n-propyl, s-butyl, t-butyl, pentyl, hexyl, cyclopentyl, cyclohexyl), an alkoxy group having 1 to 6 carbon atoms (e.g. ethoxy, methoxy, isopropoxy, n-propoxy, s-butoxy, t-butoxy, pentoxy, hexyloxy, cyclopentoxy, cyclohexyloxy), an aryl group having 5 to 40 nucleus atoms, an amino group substituted with an aryl group having 5 to 40 nucleus atoms, an ester group having an aryl group having 5 to 40 nucleus atoms, an ester group having an alkyl group having 1 to 6 carbon atoms, a cyano group, a nitro group, and a halogen atom (e.g. chlorine, bromine, iodine). Ar³⁰⁴ is preferably the above-mentioned q′-valent group.

Phosphorescent compounds can be used as an emitting material. For phosphorescence emission, a compound having a carbazole ring is preferable as the host material. A phosphorescent dopant is a compound which emits light from triplet excitons. The phosphorescent dopant is not limited so long as it can emit light from triplet excitons, but it is preferably a metal complex containing at least one metal selected from the group of Ir, Ru, Pd, Pt, Os and Re.

The compound containing a carbazole ring, which is a host suitable for phosphorescence emission, is a compound which allows a phosphorescent compound to emit as a result of energy transfer from its excited state to the phosphorescent compound. A host compound is not limited so long as the compound can transfer its excited energy to a phosphorescent compound and it can be selected depending on purposes. Other than the carbazole ring, the compound may contain an arbitrary heterocyclic ring or the like.

Specific examples of such host compounds include carbazole derivatives, triazole derivatives, oxazole derivatives, oxadiazole derivatives, imidazole derivatives, polyarylalkane derivatives, pyrazoline derivatives, pyrazolone derivatives, phenylenediamine derivatives, arylamine derivatives, amino-substituted calcone derivatives, styrylanthracene derivatives, fluorenone derivatives, hydrazone derivatives, stilbene derivatives, silazane derivatives, aromatic tertiary amine compounds, styrylamine compounds, aromatic dimethylidene compounds, porphyrin compounds, anthraquinodimethane derivatives, anthrone derivatives, diphenylquinone derivatives, thiopyrandioxide derivatives, carbodiimide derivatives, fluorenylidenemethane derivatives, distyrylpyrazine derivatives, heterocyclic tetracarboxylic anhydrides such as naphthaleneperylene, phthalocyanine derivatives, metal complexes of 8-quinolinol derivatives, various metal complex polysilane compounds represented by metal complexes having metalphthalocyanine, benzoxazole or benzothiazole as a ligand, electroconductive high-molecular-weight oligomers such as poly(N-vinylcarbazole) derivatives, aniline copolymers, thiophene oligomers and polythiophene, and high-molecular-weight compounds such as polythiophene derivatives, polyphenylene derivatives, polyphenylenevinylene derivatives and polyfluorene derivatives. The host compound may be used either singly or in a mixture of two or more.

Specific compounds shown below can be exemplified.

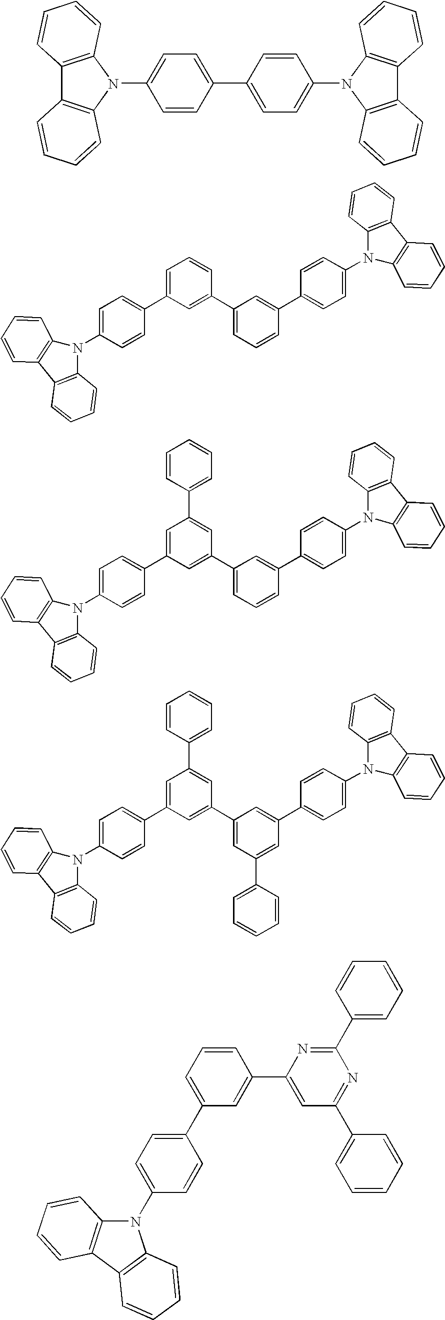

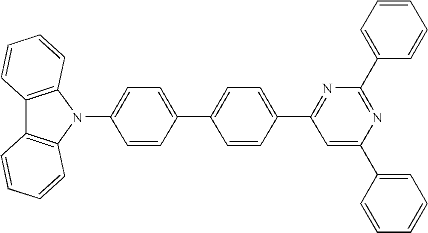

A phosphorescent dopant is a compound that can emit light from triplet excitons. The dopant is not limited so long as it can emit light from triplet excitons, but it is preferably a metal complex containing at least one metal selected from the group of Ir, Ru, Pd, Pt, Os and Re. A porphyrin metal complex or an ortho-metalated metal complex is preferable. As the porphyrin metal complex, a porphyrin platinum complex is preferable. The phosphorescent compound may be used either singly or in a mixture of two or more.

Various ligands may form an ortho-metalated metal complex. Preferable ligands include 2-phenylpyridine derivatives, 7,8-benzoquinoline derivatives, 2-(2-thienyl)pyridine derivatives, 2-(1-naphthyl)pyridine derivatives, and 2-phenylquinoline derivatives. These derivatives may contain a substituent, if necessary. Fluorides and derivatives with a trifluoromethyl group introduced are particularly preferable as a blue dopant. As an auxiliary ligand, preferred are ligands other than the above-mentioned ligands, such as acetylacetonate and picric acid may be contained.

The content of the phosphorescent dopant in the luminescent medium layer is not limited and can be appropriately selected according to purposes; for example, it is 0.1 to 70 mass %, preferably 1 to 30 mass %. When the content of the phosphorescent compound is less than 0.1 mass %, emission may be weak and the advantages thereof may not be sufficiently obtained. When the content exceeds 70 mass %, the phenomenon called concentration quenching may significantly proceed, thereby degrading the device performance.

The emitting layer may contain a hole-transporting material, an electron-transporting material, and a polymer binder, if necessary.

The thickness of the emitting layer is preferably 5 to 50 nm, more preferably 7 to 50 nm, and most preferably 10 to 50 nm. When it is less than 5 nm, formation of the emitting layer and adjustment of chromaticity may become difficult. When it exceeds 50 nm, driving voltage may increase.

Next, other members constituting the organic EL device of the invention will be described below.

### 4. Supporting Substrate

A supporting substrate is a member for supporting an organic EL device. Therefore, the supporting substrate is required to be improved in mechanical strength and dimensional stability. As examples of the material for the substrate, a glass plate, a metal plate, a ceramic plate, a plastic plate (e.g. polycarbonate resin, acrylic resin, vinyl chloride resin, polyethylene terephthalate resin, polyimide resin, polyester resin, epoxy resin, phenol resin, silicon resin, and fluororesin), and the like can be given.

It is preferred that the substrate formed of such a material be subjected to moisture-proof treatment or hydrophobic treatment by forming an inorganic film or applying a fluororesin in order to prevent water from entering the organic EL display. In order to prevent water from entering an organic luminescent medium, it is preferred that the moisture content and the gas transmission coefficient of the substrate be rendered small. Specifically, it is preferred that the supporting substrate have a moisture content of 0.0001 wt % or less and a gas transmission coefficient of 1×10⁻¹³ cc·cm/cm² Sec·cm Hg or less.

The supporting substrate is preferably transparent with a transmittance for visible light of 50% or more when light is outcoupled through the supporting substrate. However if EL emission is outcoupled through the counter electrode, the supporting substrate needs not necessarily be transparent.

### 5. Anode

As the anode, it is preferable to use metals, alloys, electric conductive compounds and mixtures thereof with a large work function (for example, 4.0 eV or more). Specifically, indium tin oxide (ITO), indium zinc oxide (IZO), indium copper, tin, zinc oxide, gold, platinum, palladium, or the like can be used singly or in a mixture of two or more.

The anode can be formed by forming these electrode materials into a thin film by vapor deposition, sputtering or the like. Although the thickness of the anode is not particularly limited, it is preferred that the anode have a thickness of 10 to 1000 nm, more preferably 10 to 200 nm. In addition, the anode is substantially transparent, i.e., has a light transmittance of 50% or more, when light irradiated from the organic luminescent medium layer is outcoupled through the anode.

### 6. Cathode

As the cathode, it is preferable to use metals, alloys, electric conductive compounds and mixtures thereof with a small work function (for example, less than 4.0 eV). Specifically, magnesium, aluminum, indium, lithium, sodium, cesium, silver or the like can be used singly or in a mixture of two or more. Although the thickness of the cathode is not particularly limited, it is preferred that the cathode has a thickness of 10 to 1000 nm, more preferably 10 to 200 nm.

This cathode can be formed by making the electrode substances into a thin film by vapor deposition, sputtering or some other methods.

In the case where emission from the emitting layer is outcoupled through the cathode, it is preferable to render the transmittance of the cathode for the emission larger than 10%.

### 7. Hole-Injecting and Transporting Layer

The hole-injecting and transporting layer is a layer for helping the injection of holes into the emitting layer to transport the holes to a light emitting region. The hole mobility thereof is large and the ionization energy thereof is usually as small as 5.5 eV or less. Such a hole-injecting and transporting layer is preferably made of a material which can transport holes to the luminescent medium layer at low electric field intensity. The hole mobility thereof is preferably at least 10⁻⁴ cm²/V second when an electric field of, for example, 10⁴ to 10⁶ V/cm is applied.

Any materials which have the above preferable properties can be used as the material for forming the hole-injecting and transporting layer without particular limitation. The material for forming the hole-injecting and transporting layer can be arbitrarily selected from materials which have been widely used as a material transporting carriers of holes in photoconductive materials and known materials used in a hole-injecting layer and transporting layer of organic EL devices.

Specific examples of materials for the hole-injecting and transporting layer include triazole derivatives (see U.S. Pat. No. 3,112,197 and others), oxadiazole derivatives (see U.S. Pat. No. 3,189,447 and others), imidazole derivatives (see JP-B-37-16096 and others), polyarylalkane derivatives (see U.S. Pat. Nos. 3,615,402, 3,820,989 and 3,542,544, JP-B-45-555 and 51-10983, JP-A-51-93224, 55-17105, 56-4148, 55-108667, 55-156953 and 56-36656, and others), pyrazoline derivatives and pyrazolone derivatives (see U.S. Pat. Nos. 3,180,729 and 4,278,746, JP-A-55-88064, 55-88065, 49-105537, 55-51086, 56-80051, 56-88141, 57-45545, 54-112637 and 55-74546, and others), phenylene diamine derivatives (see U.S. Pat. No. 3,615,404, JP-B-51-10105, 46-3712 and 47-25336, 54-119925, and others), arylamine derivatives (see U.S. Pat. Nos. 3,567,450, 3,240,597, 3,658,520, 4,232,103, 4,175,961 and 4,012,376, JP-B-49-35702 and 39-27577, JP-A-55-144250, 56-119132 and 56-22437, DE1,110,518, and others), amino-substituted chalcone derivatives (see U.S. Pat. No. 3,526,501, and others), oxazole derivatives (ones disclosed in U.S. Pat. No. 3,257,203, and others), styrylanthracene derivatives (see JP-A-56-46234, and others), fluorenone derivatives (JP-A-54-110837, and others), hydrazone derivatives (see U.S. Pat. No. 3,717,462, JP-A-54-59143, 55-52063, 55-52064, 55-85495, 57-11350, 57-148749 and 2-311591, and others), stilbene derivatives (see JP-A-61-210363, 61-228451, 61-14642, 61-72255, 62-47646, 62-36674, 62-10652, 62-30255, 60-93455, 60-94462, 60-174749 and 60-175052, and others), silazane derivatives (U.S. Pat. No. 4,950,950), polysilanes (JP-A-2-204996), aniline copolymers (JP-A-2-282263), and electroconductive high-molecular-weight oligomers (in particular thiophene oligomers).

The above substances can be used for the hole-injecting and transporting layer. The following can also be used: porphyrin compounds (disclosed in JP-A-63-2956965 and others), aromatic tertiary amine compounds and styrylamine compounds (see U.S. Pat. No. 4,127,412, JP-A-53-27033, 54-58445, 55-79450, 55-144250, 56-119132, 61-295558, 61-98353 and 63-295695, and others). Aromatic tertiary amine compounds are particularly preferably used.

Preferred examples of the hole-injecting and transporting material used in the hole-injecting and transporting layer include a compound represented by the following formula:

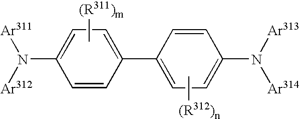

wherein Ar³¹¹ to Ar³¹⁴ are independently a substituted or unsubstituted aryl group having 6 to 50 nucleus carbon atoms; R³¹¹ to R³¹² are independently a hydrogen atom, a substituted or unsubstituted aryl group having 6 to 50 nucleus carbon atoms or an alkyl group having 1 to 50 carbon atoms; and m and n are an integer of 0 to 4.

Preferred examples of the aryl group having 6 to 50 nucleus carbon atoms include phenyl, naphthyl, biphenyl, terphenyl, and phenanthryl. The aryl group having 6 to 50 nucleus carbon atoms may further be substituted with a substituent. Preferable substituents include an alkyl group having 1 to 6 carbon atoms (e.g. methyl, ethyl, isopropyl, n-propyl, s-butyl, t-butyl, pentyl, hexyl, cyclopentyl, cyclohexyl) and an amino group substituted with an aryl group having 6 to 50 nucleus carbon atoms.

The following can also be given as examples: 4,4′-bis(N-(1-naphthyl)-N-phenylamino)biphenyl (abbreviated by NPD hereinafter), which has in the molecule thereof two condensed aromatic rings, disclosed in U.S. Pat. No. 5,061,569, and 4,4′,4″-tris(N-(3-methylphenyl)-N-phenylamino)triphenylamine (abbreviated by MTDATA, hereinafter), wherein three triphenylamine units are linked to each other in a star-burst form, disclosed in JP-A-4-308688.

Inorganic compounds such as p-type Si and p-type SiC as well as aromatic dimethylidene type compounds can also be used as the material of the hole-injecting and transporting layer.

The hole-injecting and transporting layer can be formed by making the above-mentioned compounds into a thin film by a known method such as vacuum deposition, spin coating, casting or LB technique. The film thickness of the hole-injecting and transporting layer is not particularly limited, and is usually from 5 nm to 5 μm. As long as the above-mentioned compounds are contained in the hole-transporting region, the hole-injecting and transporting layer may be a single layer formed of one or two or more of the above materials, or may be a multilayer-stack obtained by stacking a plurality of hole-injecting and transporting layer formed of different compounds.

### 8. Insulative Layer

In the organic EL device, pixel defects based on leakage or short circuit are easily generated since an electric field is applied to an ultra thin film. In order to prevent this, it is preferred to insert an insulative thin layer between the pair of electrodes.

Examples of the material used in the insulative layer include aluminum oxide, lithium fluoride, lithium oxide, cesium fluoride, cesium oxide, magnesium oxide, magnesium fluoride, calcium oxide, calcium fluoride, cesium fluoride, cesium carbonate, aluminum nitride, titanium oxide, silicon oxide, germanium oxide, silicon nitride, boron nitride, molybdenum oxide, ruthenium oxide and vanadium oxide.

A mixture or multilayer-stack thereof may be used.

### 9. Others

A preferred embodiment of the invention is a device containing a reducing dopant in an interfacial region between its electron-transporting and injecting region or cathode and organic layer. The reducing dopant is defined as a substance which can reduce an electron-transporting compound. Accordingly, various substances which have given reducing properties can be used. For example, at least one substance can be preferably used which is selected from the group consisting of alkali metals, alkaline earth metals, rare earth metals, alkali metal oxides, alkali metal halides, alkaline earth metal oxides, alkaline earth metal halides, rare earth metal oxides, rare earth metal halides, alkali metal organic complexes, alkaline earth metal organic complexes, and rare earth metal organic complexes.

More specific examples of the preferred reducing dopants include at least one alkali metal selected from the group consisting of Na (work function: 2.36 eV), K (work function: 2.28 eV), Rb (work function: 2.16 eV) and Cs (work function: 1.95 eV), and at least one alkaline earth metal selected from the group consisting of Ca (work function: 2.9 eV), Sr (work function: 2.0 to 2.5 eV), and Ba (work function: 2.52 eV). Metals having a work function of 2.9 eV or less are particularly preferred. Among these, a more preferable reducing dopant is at least one alkali metal selected from the group consisting of K, Rb and Cs. Even more preferable is Rb or Cs. Most preferable is Cs. These alkali metals are particularly high in reducing ability. Thus, the addition of a relatively small amount thereof to an electron-injecting zone improves the luminance of the organic EL device and make the life thereof long. As a reducing dopant having a work function of 2.9 eV or less, combinations of two or more alkali metals are preferable. Particularly, combinations including Cs, such as Cs and Na, Cs and K, Cs and Rb, or Cs, Na and K are preferable. The combination containing Cs makes it possible to exhibit the reducing ability efficiently. The luminance of the organic EL device can be improved and the life thereof can be made long by the addition thereof to its electron-injecting zone.

In the invention, an electron-injecting layer made of an insulator or a semiconductor may further be provided between a cathode and an organic layer. By providing the layer, current leakage can be effectively prevented to improve the injection of electrons. As the insulator, at least one metal compound selected from the group consisting of alkali metal calcogenides, alkaline earth metal calcogenides, halides of alkali metals and halides of alkaline earth metals can be preferably used. When the electron-injecting layer is formed of the alkali metal calcogenide or the like, the injection of electrons can be preferably further improved. Specifically, preferable alkali metal calcogenides include Li₂O, LiO, Na₂S, Na₂Se and NaO and preferable alkaline earth metal calcogenides include CaO, BaO, SrO, BeO, BaS and CaSe. Preferable halides of alkali metals include LiF, NaF, KF, LiCl, KCl and NaCl. Preferable halides of alkaline earth metals include fluorides such as CaF₂, BaF₂, SrF₂, MgF₂ and BeF₂ and halides other than fluorides. Semiconductors forming an electron-transporting layer include one or combinations of two or more oxides, nitrides, and oxidized nitrides containing at least one element of Ba, Ca, Sr, Yb, Al, Ga, In, Li, Na, Cd, Mg, Si, Ta, Sb and Zn. An inorganic compound forming an electron-transporting layer is preferably a microcrystalline or amorphous insulative thin film. When the electron-transporting layer is formed of the insulative thin films, a more uniformed thin film is formed whereby pixel defects such as a dark spot are decreased. Examples of such an inorganic compound include the above-mentioned alkali metal calcogenides, alkaline earth metal calcogenides, halides of alkali metals, and halides of alkaline earth metals.

The organic EL device can be fabricated by forming necessary layers successively from the anode, and finally forming the cathode using the materials and methods exemplified above. The organic EL device can be fabricated in the order reverse to the above, i.e., the order from the cathode to the anode. An example of the fabrication of the organic EL device will be described below, wherein the following are successively formed on a transparent substrate: anode/hole-transporting layer/emitting layer/electron-transporting layer/electron-injecting layer/cathode.

First, a thin film made of an anode material is formed into a thickness of 1 μm or less, preferably 10 to 200 nm on an appropriate transparent substrate by vapor deposition, sputtering or some other method, thereby forming an anode. Next, a hole-transporting layer is formed on this anode. As described above, the hole-transporting layer can be formed by vacuum deposition, spin coating, casting, LB technique, or some other method. Vacuum deposition is preferable since a homogenous film is easily obtained and pinholes are not easily generated. In the case where the hole-transporting layer is formed by vacuum deposition, conditions for the deposition vary depending upon the compound used (the material for the hole-transporting layer), the desired crystal structure or recombining structure of the hole-transporting layer, and others. In general, the conditions are preferably selected from the following: deposition source temperature of 50 to 450° C., vacuum degree of 10⁻⁷ to 10⁻³ torr, vapor deposition rate of 0.01 to 50 nm/second, substrate temperature of −50 to 300° C., and film thickness of 5 nm to 5 μm.

Next, an emitting layer is formed on this hole-transporting layer. The emitting layer can also be formed by making a desired organic luminescent material into a thin film by vacuum deposition, sputtering, spin coating, casting or some other methods. Vacuum deposition is preferable since a homogenous film is easily obtained and pinholes are not easily generated. In the case where the emitting layer is formed by vacuum deposition, conditions for the deposition, which vary depending on a compound used, can be generally selected from conditions similar to those for the hole-transporting layer.

Then, an electron-transporting layer is formed on this emitting layer, followed by the formation of the electron-injecting layer. Like the hole-transporting layer and the emitting layer, the layer is preferably formed by vacuum deposition because a homogenous film is required. Conditions for the deposition can be selected from conditions similar to those for the hole-transporting layer and the emitting layer.

Lastly, a cathode is stacked thereon to obtain an organic EL device.

The cathode is made of a metal, and vapor deposition or sputtering may be used. However, vacuum deposition is preferred in order to protect underlying organic layers from being damaged when the cathode film is formed.

For the organic EL device fabrication that has been described above, it is preferred that the formation from the anode to the cathode be continuously carried out, using only one vacuuming operation.

The method for forming each of the layers in the organic EL device of the invention is not particularly limited. A known forming method such as vacuum deposition or spin coating can be used.

The film thickness of each of the organic layers in the organic EL device of the invention is not particularly limited. In general, defects such as pinholes are easily generated when the film thickness is too small. Conversely, when the film thickness is too large, a high applied voltage becomes necessary, leading to low efficiency. Usually, the film thickness is preferably in the range of several nanometers to one micrometer.

If a DC voltage is applied to the organic EL device, emission can be observed when the polarities of the anode and the cathode are positive and negative, respectively, with application of a DC voltage of 5 to 40 V. When a voltage with an opposite polarity is applied, no electric current flows and hence, emission does not occur. If an AC voltage is applied, uniform emission can be observed only when the anode and the cathode have a positive polarity and a negative polarity, respectively. The waveform of the AC applied may be arbitrary.

### EXAMPLES

Examples of the invention will be given below in detail. However, the invention is not limited to the examples. The properties of the compounds used and devices fabricated in each example were evaluated by the following method.

(1) Energy gap: Measured based on an absorption edge of an absorption spectrum in benzene. Specifically, the absorption spectrum was measured by means of a UV-visible spectrophotometer (U-3410, manufactured by Hitachi, Ltd.), and the energy gap was calculated from a wavelength at which the spectrum starts to rise.
(2) Electron mobility: Measured by means of a TIME OF FLIGHT measuring apparatus (TOF-301, manufactured by Optel, Co., Ltd.)
(3) Luminance: Measured by means of a spectroradiometer (CS-1000, manufactured by Konica Minolta Sensing, Inc.)
(4) x,y of Chromaticity coordinate CIE 1931: Measured by the spectroradiometer mentioned in (3) above.
(5) Luminous efficiency (L/J):L/J is a ratio of luminance to current density. A current and a voltage were measured by a SOURCE MEASURE UNIT 236 (manufactured by KEITHLEY), and at the same time, luminance was measured by means of a spectroradiometer. Current density was calculated from a current value and an emission area, and L/J was calculated.
(6) Fluorescence quantum yield: Measured by means of an absolute luminescence quantum yield measuring apparatus equipped with an integrating sphere (manufactured by Hamamatsu Photonics, K.K.)

The structures of compounds used in the electron-transporting layer, the electron-injecting layer, and the emitting layer in the following Examples and Comparative Examples are given below. The electron mobility and the energy band gap (Eg) are shown in Table 1.

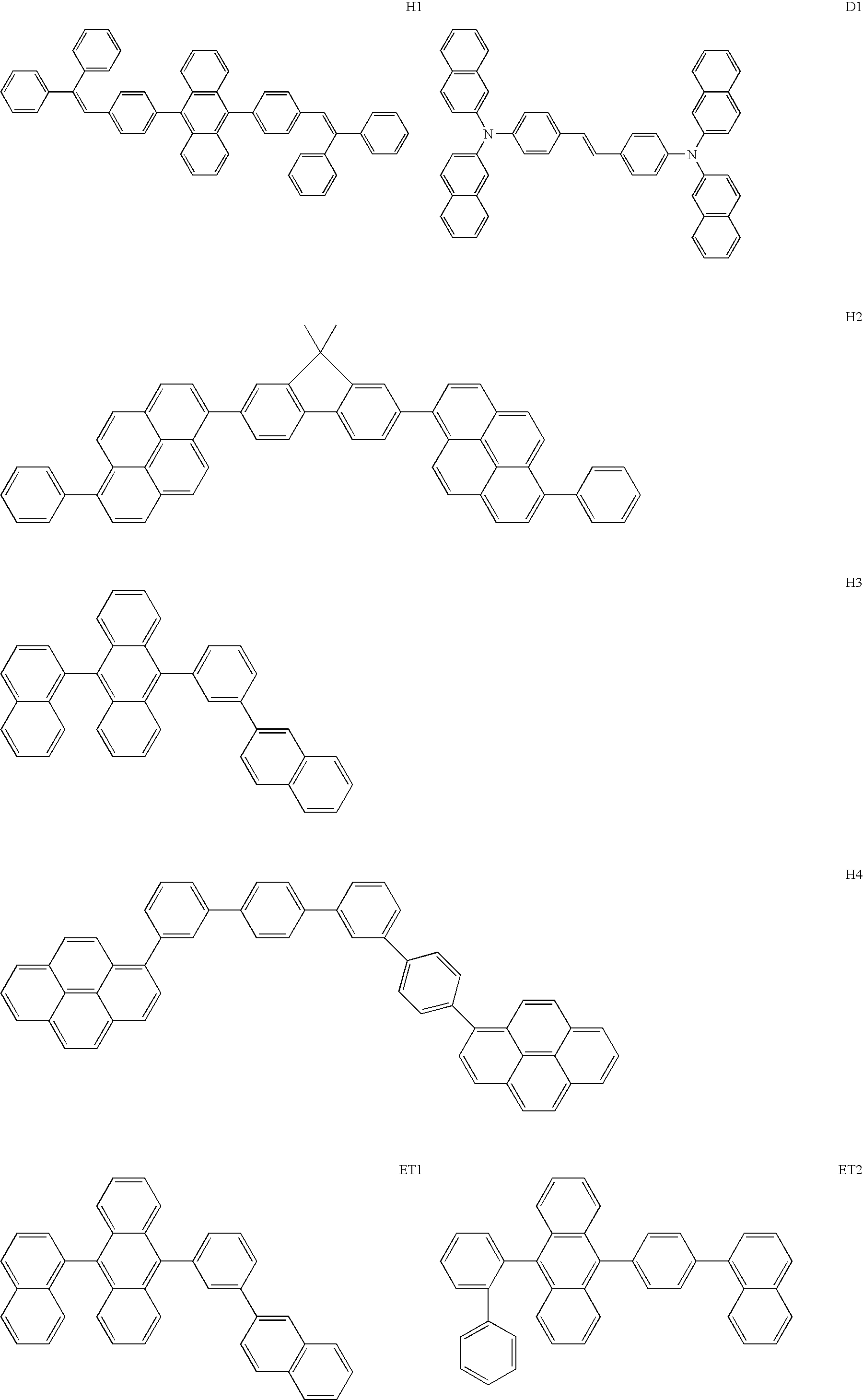

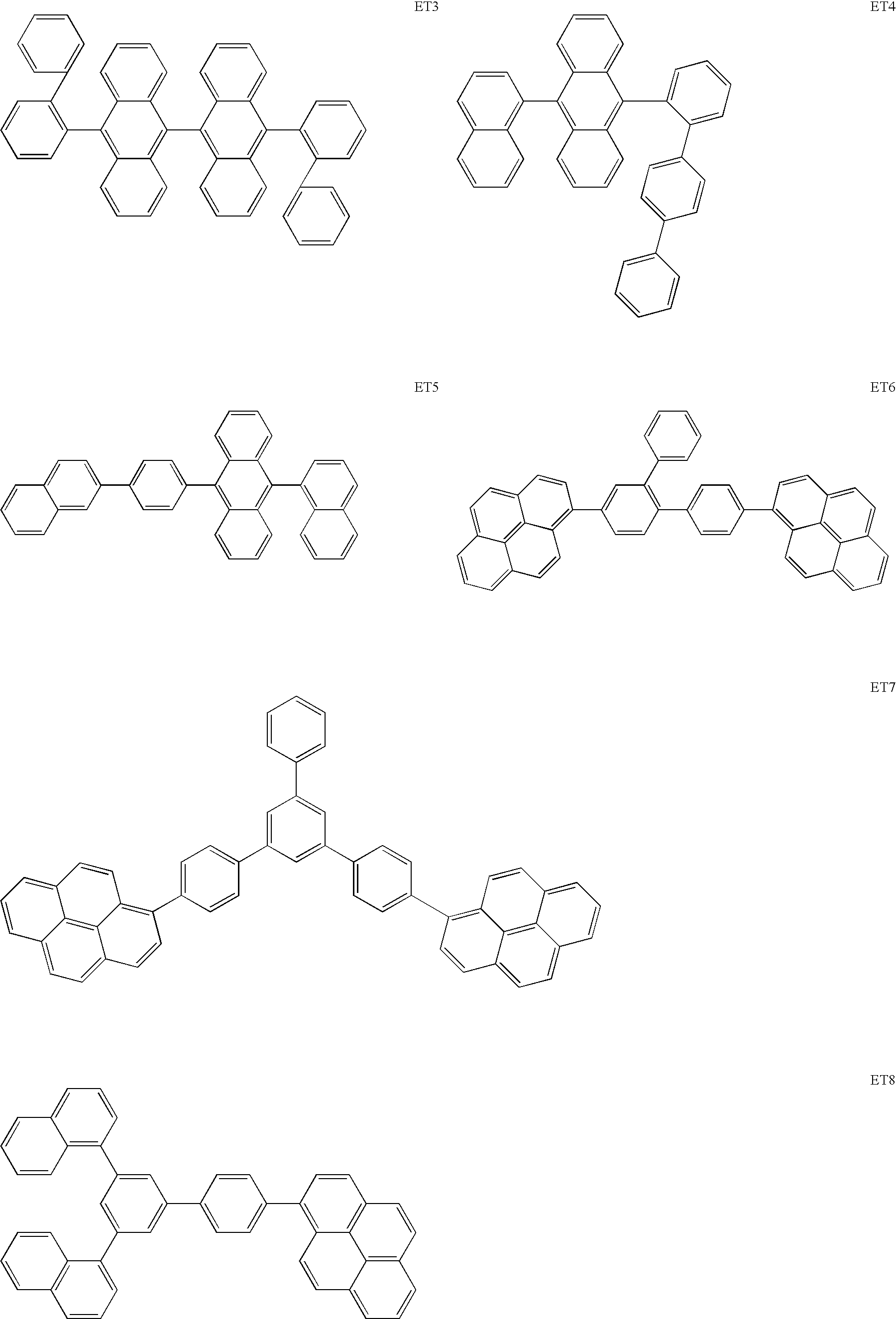

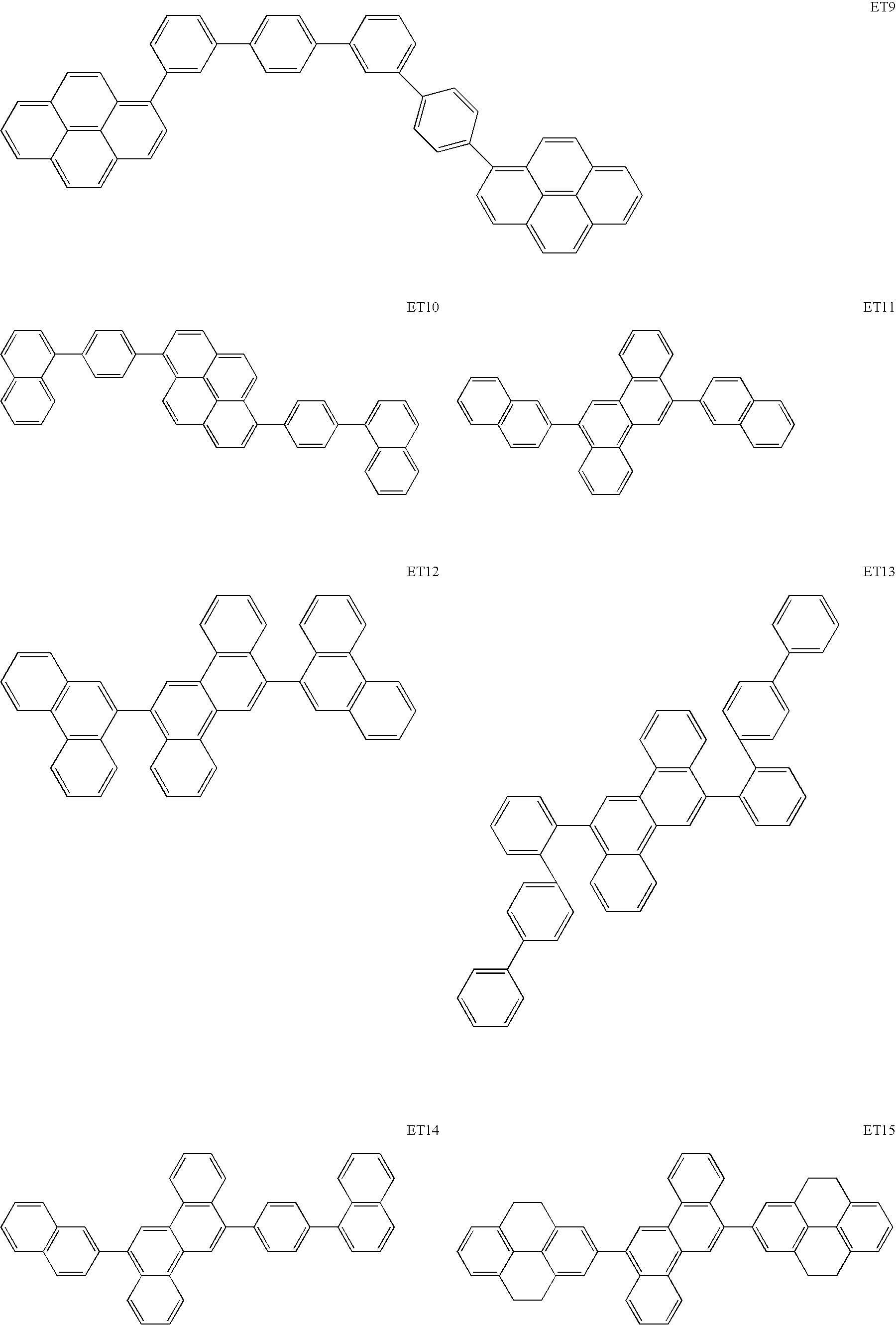

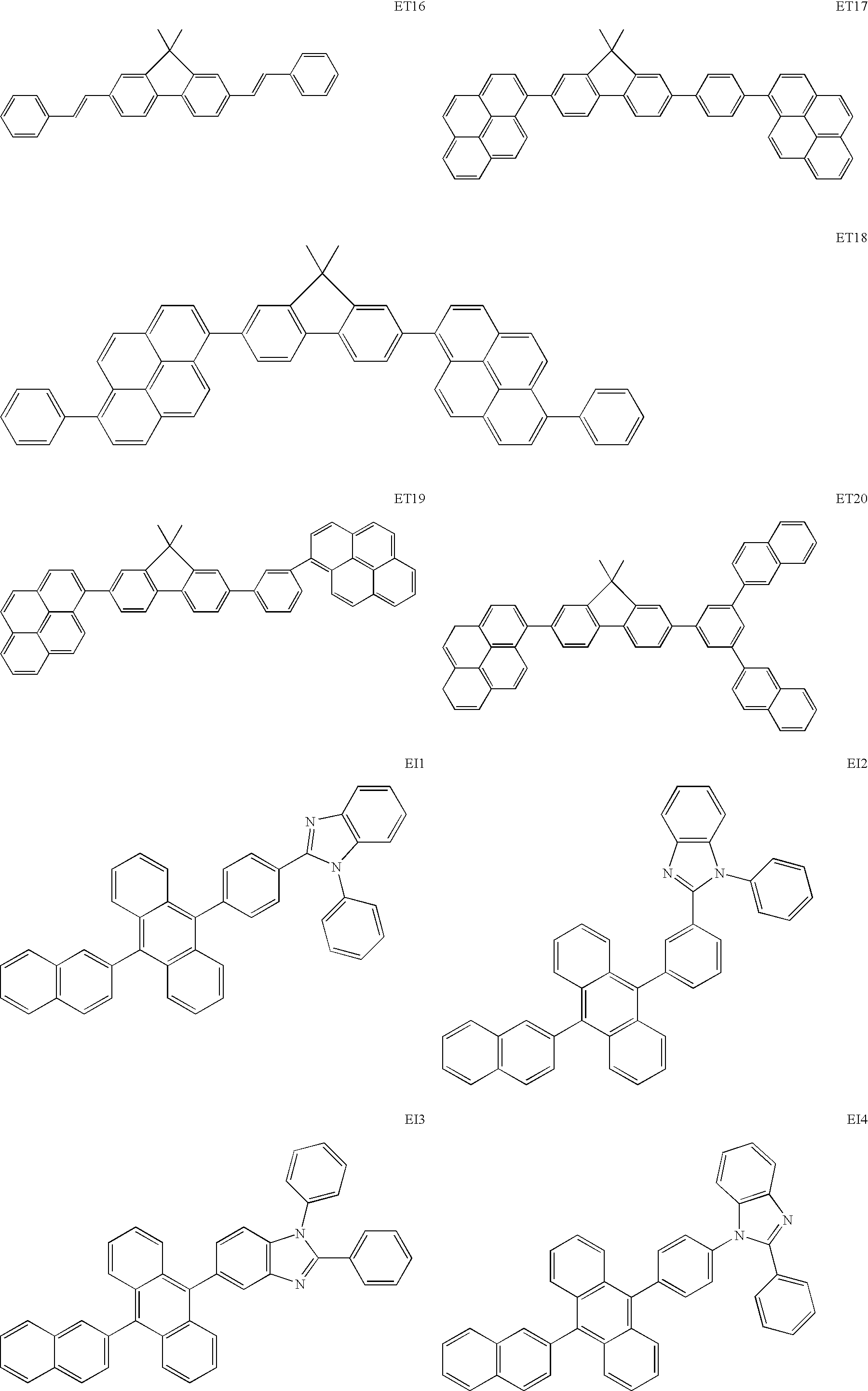

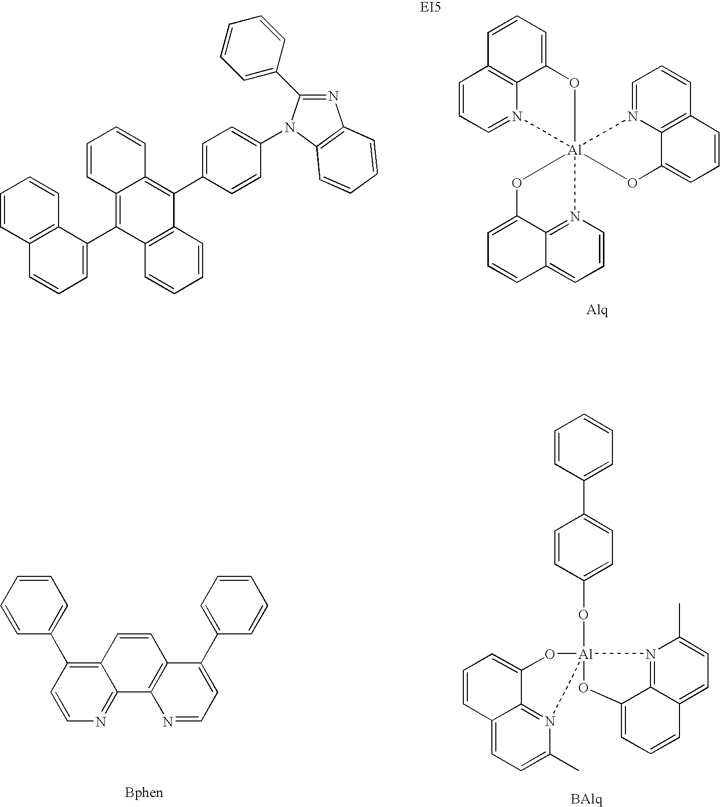

TABLE 1

| Compound | Electron mobility (cm²/V · s) | Energy gap Eg (eV) |
|---|---|---|
| H1 | — | 3.0 |
| ET1 | 10⁻⁴ | 3.0 |
| ET2 | 10⁻⁴ | 3.0 |
| ET3 | 10⁻⁴ | 3.0 |
| ET4 | 10⁻⁴ | 3.0 |
| ET5 | 10⁻⁴ | 3.0 |
| ET6 | 10⁻⁴ | 3.0 |
| ET7 | 10⁻⁴ | 3.0 |
| ET8 | 10⁻⁴ | 3.0 |
| ET9 | 10⁻⁴ | 3.0 |
| ET10 | 10⁻⁴ | 3.0 |
| ET11 | 10⁻⁴ | 3.0 |
| ET12 | 10⁻⁴ | 3.0 |
| ET13 | 10⁻⁴ | 3.0 |
| ET14 | 10⁻⁴ | 3.0 |
| ET15 | 10⁻⁴ | 3.0 |
| ET16 | 10⁻⁴ | 3.0 |
| ET17 | 10⁻⁴ | 3.0 |
| ET18 | 10⁻⁴ | 3.0 |
| ET19 | 10⁻⁴ | 3.0 |
| ET20 | 10⁻⁴ | 3.0 |
| EI2 | 10⁻⁴ | 3.0 |
| Alq | 10⁻⁵ | 2.7 |
| BAlq | 10⁻⁵ | 3.3 |

In Table 1, “10⁻⁴” means that the electron mobility is of the order of 10⁻⁴.

### Example 1

A glass substrate of 25 mm by 75 mm by 1.1 mm thick with an ITO transparent electrode (film thickness: 130 nm) (GEOMATEC Co., Ltd.) was subjected to ultrasonic cleaning with isopropyl alcohol for 5 minutes, followed by ultrasonic cleaning with distilled water having an electric resistance of 20 MΩm for 5 minutes. The ITO substrate was further subjected to ultrasonic cleaning with isopropyl alcohol for 5 minutes. Thereafter, the ITO substrate was taken out and dried. Immediately after, the substrate was then subjected to UV-ozone cleaning for 30 minutes by means of an UV-ozone cleaning apparatus manufactured by SAMCO International, Inc.

The cleaned glass substrate with transparent electrode lines formed thereon was secured to a substrate holder of a vacuum deposition apparatus. The inside of the apparatus was vacuumed to 1×10⁻⁵ Pa. Subsequently, a 60 nm-thick N,N′-bis(N,N′-diphenyl-4-aminophenyl)-N,N-diphenyl-4,4′-diamino-1,1′-biphenyl (hereinafter abbreviated as the “TPD 232 film”) was formed at a deposition speed of 0.1 nm/sec on the surface on which the transparent electrode lines were formed such that the transparent electrode was covered. This TPD 232 film functioned as a hole-injecting layer.

Subsequently, a 20 nm-thick N,N,N′,N′-tetra(4-biphenyl)-diaminobiphenylene layer (hereinafter abbreviated as the “TBDB layer”) was formed on this TPD 232 film at a deposition speed of 0.1 nm/sec. This film functioned as a hole-transporting layer. Further, host material H1 was formed into a 40 nm-thick film at a deposition speed of 0.2 nm/sec. At the same time, as an emitting molecule, dopant D1 was deposited at a deposition speed of 0.01 nm/sec. This film functioned as an emitting layer.

On the emitting layer, as an electron-transporting layer, ET1 was formed into a 7 nm-thick film at a deposition speed of 0.1 nm/sec. Further, as an electron-injecting layer, compound EI1 was formed into a 13 nm-thick film at a deposition speed of 0.1 nm/sec. Lithium fluoride LiF was formed into a 1 nm-thick film at a deposition speed of 0.01 nm/second. Metal Al was deposited thereon at a deposition speed of 0.8 nm/second to form a metal cathode. As a result, an organic EL device was fabricated.

The properties of the organic EL device were measured. The results are shown in Table 2. In Table 2, numerals in parenthesis in the rows of the emitting layer and the electron-transporting layer indicate the fluorescence quantum yield. The luminance half life was 1290 hours.

### Examples 2 to 26

Organic EL devices were fabricated in the same manner as in Example 1, except that the materials shown in Table 2 were used as the material for the electron-transporting layer or the electron-injecting layer. The results of the evaluation of the device are shown in Table 2. The luminance half life of the device was the same as that of the device in Example 1.

### Comparative Example 1

An organic EL device was fabricated in the same manner as in Example 1, except that the E11 film as the electron-injecting layer was not formed and the thickness of the ET1 film as the electron-transporting layer was changed to 20 nm. The results of the evaluation of the device are shown in Table 2.

This organic EL device suffered non-uniform emission. In addition, as compared with the device in Example 1, it was confirmed that this organic EL device had a high driving voltage and a significant low L/J efficiency. The luminance half life was reduced to one-several tenth of that of the device in Example 1.

### Comparative Example 2

An organic EL device was fabricated in the same manner as in Example 1, except that the ET1 film as the electron-transporting layer was not formed and the thickness of the EI2 film as the electron-injecting layer was changed to 20 nm. The results of the evaluation of the device are shown in Table 3.

The luminance half life of this organic EL device was reduced to one-tenth of that of the device in Example 1.

### Comparative Example 3

An organic EL device was fabricated in the same manner as in Example 1, except that Alq was used as the material for the electron-transporting layer, the thickness of the electron-transporting layer was changed to 20 nm, and the electron-injecting layer was not formed. The results of the evaluation of the device are shown in Table 3.

It was confirmed that this organic EL device had a higher driving voltage as compared with the device of Example 1. It was also confirmed that the luminance half life was reduced to one-tenth of that of the device in Example 1.

### Comparative Example 4

An organic EL device was fabricated in the same manner as in Example 1, except that Alq was used as the material of the electron-injecting layer. The results of the evaluation of the device are shown in Table 3.

It was confirmed that this organic EL device had a higher driving voltage as compared with the device of Example 1. The luminance half life was reduced to one-tenth of that of the device in Example 1.

### Comparative Example 5

An organic EL device was fabricated in the same manner as in Example 1, except that the electron-injecting layer was formed by co-depositing Bphen and L¹ by means of an alkali dispenser manufactured by Saes Getters, Inc., and the lithium fluoride (LiF) layer was not formed. The results of evaluation of the device are shown in Table 3.

This organic EL device had a higher driving voltage as compared with the device in Example 1. The luminance half life was reduced to one-fifth of that of the device in Example 1, and had a significantly short storage life at high temperatures.

### Comparative Example 6

An organic EL device was fabricated in the same manner as in Example 1, except that BAlq was used as the material of the electron-transporting layer, the electron-injecting layer was formed by co-depositing Bphen and Li by means of an alkali dispenser manufactured by Saes Getters, Inc., and the lithium fluoride (LiF) layer was not formed. The results of evaluation of the device are shown in Table 3.

This organic EL device had a higher driving voltage as compared with the device in Example 1. The luminance half life was reduced to one-fifth of that of the device in Example 1, and had a significantly short storage life at high temperatures.

### Comparative Example 7

An organic EL device was fabricated in the same manner as in Example 1, except that ET1 was used as the host material for the emitting layer and ET2 was used as the material for the electron-injecting layer. The results of evaluation of the device are shown in Table 2.

This organic EL device had a luminous efficiency which was lower than that of the device in Example 1. The luminous half life was reduced by 30% as compared with the device in Example 1.

TABLE 2

| | Host | | | Driving | | | |
|---|---|---|---|---|---|---|---|
| | material | | | voltage | | Color | |
| | for | Electron- | Electron- | at 10 | Luminous | of | |
| | emitting | transporting | injecting | mA/cm² | efficiency | emitted | Life |
| | layer | layer | layer | (V) | (cd/A) | light | (h) |
| Ex. 1 | H1(0.24) | ET1(0.19) | EI1 | 5.0 | 8.0 | Blue | 1290 |
| Ex. 2 | H1 | ET2(0.18) | EI2 | 5.2 | 7.8 | Blue | 1170 |
| Ex. 3 | H1 | ET3(0.15) | EI3 | 5.1 | 7.6 | Blue | 1310 |
| Ex. 4 | H1 | ET4(0.16) | EI4 | 5.2 | 7.6 | Blue | 1190 |
| Ex. 5 | H1 | ET5(0.11) | EI5 | 5.3 | 7.7 | Blue | 1220 |
| Ex. 6 | H1 | ET6(0.17) | EI1 | 5.3 | 7.2 | Blue | 1160 |
| Ex. 7 | H1 | ET7(0.19) | EI3 | 5.5 | 7.7 | Blue | 1100 |
| Ex. 8 | H1 | ET8(0.16) | EI2 | 5.0 | 7.5 | Blue | 1140 |
| Ex. 9 | H1 | ET9(0.18) | EI4 | 5.0 | 7.8 | Blue | 1130 |
| Ex. 10 | H1 | ET10(0.18) | EI5 | 5.2 | 7.7 | Blue | 1150 |
| Ex. 11 | H1 | ET11(0.13) | EI3 | 5.1 | 7.7 | Blue | 1210 |
| Ex. 12 | H1 | ET12(0.12) | EI3 | 5.0 | 7.4 | Blue | 1290 |
| Ex. 13 | H1 | ET13(0.11) | EI4 | 4.9 | 7.9 | Blue | 1340 |
| Ex. 14 | H1 | ET14(0.15) | EI2 | 5.4 | 7.5 | Blue | 1200 |
| Ex. 15 | H1 | ET15(0.16) | EI2 | 5.2 | 7.5 | Blue | 1150 |
| Ex. 16 | H1 | ET16(0.17) | EI2 | 5.3 | 7.8 | Blue | 1160 |
| Ex. 17 | H1 | ET17(0.16) | EI4 | 5.3 | 7.9 | Blue | 1160 |
| Ex. 18 | H1 | ET18(0.19) | EI5 | 5.5 | 8.0 | Blue | 1140 |
| Ex. 19 | H1 | ET19(0.18) | EI1 | 5.2 | 7.7 | Blue | 1200 |
| Ex. 20 | H1 | ET20(0.16) | EI3 | 5.0 | 7.5 | Blue | 1120 |
| Ex. 21 | H2(0.19) | ET4(0.16) | EI3 | 5.3 | 7.8 | Blue | 1090 |
| Ex. 22 | H2 | ET11(0.11) | EI5 | 5.1 | 7.8 | Blue | 1100 |
| Ex. 23 | H3(0.19) | ET4(0.16) | EI4 | 5.2 | 8.1 | Blue | 1310 |
| Ex. 24 | H3 | ET11(0.11) | EI3 | 5.1 | 7.9 | Blue | 1250 |
| Ex. 25 | H4(0.18) | ET4(0.16) | EI2 | 5.3 | 7.8 | Blue | 1060 |
| Ex. 26 | H4 | ET11(0.11) | EI1 | 5.0 | 7.9 | Blue | 1080 |
| Com. Ex. 1 | H1(0.24) | ET1(0.19) | EI1 | 8.8 | 2.4 | Blue | 40 |
| Com. Ex. 2 | H1 | EI2(0.18) | EI2 | 4.6 | 7.4 | Blue | 100 |
| Com. Ex. 3 | H1 | Alq(0.20) | — | 7.1 | 7.5 | Blue | 110 |
| Com. Ex. 4 | H1 | ET1(0.19) | Alq | 6.8 | 7.2 | Blue | 110 |
| Com. Ex. 5 | H1 | ET1(0.19) | BPhen:Li | 6.6 | 6.9 | Blue | 230 |
| Com. Ex. 6 | H1 | BAlq(0.40) | BPhen:Li | 6.3 | 7.8 | Blue | 220 |
| Com. Ex. 7 | ET1(0.19) | ET1(0.19) | ET2 | 5.2 | 6.3 | Blue | 890 |

### INDUSTRIAL APPLICABILITY

The organic EL device of the invention can be used in the fields of various displays, back light, light sources, indicators, signboards, interiors and the like, and it is particularly suitable for a display device of color displays.

The disclosures of the documents cited in this specification are incorporated herein in its entirety by reference.

While the invention has been particularly shown and described with reference to embodiments and/or examples thereof, it will be understood by those skilled in the art that various changes in form and details can be made therein without departing from the scope of the invention, and these changes are included in the scope of the invention.

1. An organic electroluminescent device comprising:
an anode,
a cathode, and
at least an emitting layer, an electron-transporting layer and an electron-injecting layer interposed between the anode and the cathode;
the emitting layer containing a host material which is a pyrene derivative, a chrysene derivative, a fluorene derivative or an anthracene derivative;
the electron-transporting layer containing an electron-transporting material which is a pyrene derivative, a chrysene derivative, a fluorene derivative or an anthracene derivative, the anthracene derivative containing no heterocyclic ring, and has a fluorescence quantum yield which is smaller than that of the host material contained in the emitting layer; and
the electron-injecting layer containing a non-complex compound having a nitrogen-containing five-membered heterocyclic structure.

2. The organic electroluminescent device according to claim 1, wherein the fluorescence quantum yield of the host material contained in the emitting layer is 0.15 to 1, and the fluorescence quantum yield of the electron-transporting material contained in the electron-transporting layer is 0.1 to 0.2.

3. The organic electroluminescent device according to claim 1, wherein the electron-transporting material of the electron-transporting layer is an aromatic compound represented by the following formula (1), excluding 2-(1,1-dimethylethyl)-9,10-bis(2-naphthalenyl)anthracene and 9,10-di-(2-naphthyl)anthracene: 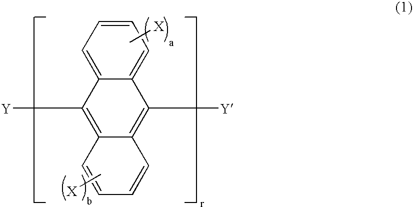
wherein Y and Y′ are independently a substituted or unsubstituted aryl group having 5 to 60 nucleus atoms;
X is independently a substituted or unsubstituted aryl group having 6 to 50 nucleus carbon atoms, a substituted or unsubstituted alkyl group having 1 to 50 carbon atoms, a substituted or unsubstituted alkoxy group having 1 to 50 carbon atoms, a substituted or unsubstituted aralkyl group having 6 to 50 carbon atoms, a substituted or unsubstituted aryloxy group having 5 to 50 nucleus atoms, a substituted or unsubstituted arylthio group having 5 to 50 nucleus atoms, a substituted or unsubstituted alkoxycarbonyl group having 1 to 50 carbon atoms, a carboxyl group, a halogen atom, a cyano group, a nitro group, or a hydroxyl group;
a and b are each an integer of 0 to 4;
r is an integer of 1 to 3; and when r, a or b is plural, Xs may be the same or different.

4. The organic electroluminescent device according to claim 1, wherein the electron-transporting material of the electron-transporting layer is an aromatic compound represented by the following formula (2): 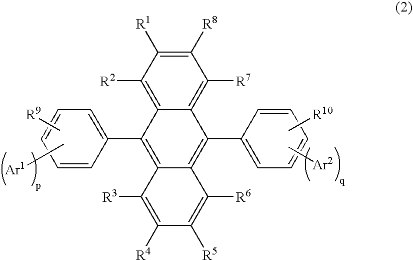
wherein Ar¹ or Ar² are independently a substituted or unsubstituted aryl group having 6 to 50 nucleus carbon atoms;
p and q are each an integer of 1 to 4; when p or q is plural, Ar¹s and Ar²s may be the same or different; and
R¹ to R¹⁰ are independently a hydrogen atom, a substituted or unsubstituted aryl group having 6 to 50 nucleus carbon atoms a substituted or unsubstituted alkyl group having 1 to 50 carbon atoms, a substituted or unsubstituted cycloalkyl group, a substituted or unsubstituted alkoxy group having 1 to 50 carbon atoms, a substituted or unsubstituted aralkyl group having 6 to 50 carbon atoms, a substituted or unsubstituted aryloxy group having 5 to 50 nucleus atoms, a substituted or unsubstituted arylthio group having 5 to 50 nucleus atom, a substituted or unsubstituted alkoxycarbonyl group having 1 to 50 carbon atoms, a substituted or unsubstituted silyl group, a carboxyl group, a halogen atom, a cyano group, a nitro group, or a hydroxyl group.

5. The organic electroluminescent device according to claim 1, wherein the electron-transporting material of the electron-transporting layer is an aromatic compound represented by the following formula (3), excluding 2-(1,1-dimethylethyl)-9,10-bis(2-naphthalenyl)anthracene and 9,10-di-(2-naphthyl)anthracene: 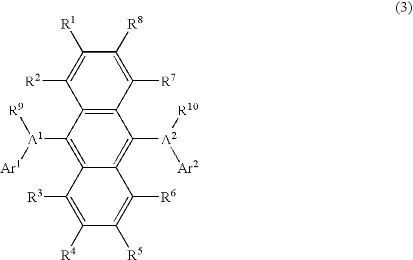
wherein A¹ and A² are independently a substituted or unsubstituted condensed aromatic ring group having 10 to 20 nucleus carbon atoms;
Ar¹ and Ar² are independently a hydrogen atom or a substituted or unsubstituted aryl group having 6 to 50 nucleus carbon atoms;
R¹ to R¹⁰ are independently a hydrogen atom, a substituted or unsubstituted aryl group having 6 to 50 nucleus carbon atoms, a substituted or unsubstituted alkyl group having 1 to 50 carbon atoms, a substituted or unsubstituted cycloalkyl group, a substituted or unsubstituted alkoxy group having 1 to 50 carbon atoms, a substituted or unsubstituted aralkyl group having 6 to 50 carbon atoms, a substituted or unsubstituted aryloxy group having 5 to 50 nucleus atoms, a substituted or unsubstituted arylthio group having 5 to 50 nucleus atoms, a substituted or unsubstituted alkoxycarbonyl group having 1 to 50 carbon atoms, a substituted or unsubstituted silyl group, a carboxyl group, a halogen atom, a cyano group, a nitro group or a hydroxyl group; and
adjacent groups of Ar¹, Ar², R⁹ and R¹⁰ may form a saturated or unsaturated cyclic structure.

6. The organic electroluminescent device according to claim 1, wherein the electron-transporting material of the electron-transporting layer is an aromatic compound represented by the following formula (4): 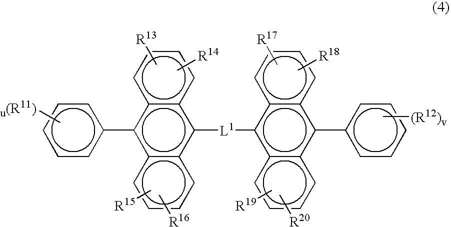
wherein R¹¹ to R²⁰ are independently a hydrogen atom, an alkyl group, a cycloalkyl group, a substituted or unsubstituted aryl group, an alkoxyl group, an aryloxy group, an alkylamino group, an alkenyl group or an arylamino group;
u and v are each an integer of 1 to 5, and when they are 2 or more, R¹¹s or R¹²s may be the same or different and R¹¹s and R¹²s may bond to each other to form a ring;
R¹³ and R¹⁴, R¹⁵ and R¹⁶, R¹⁷ and R¹⁸, R¹⁹ and R²⁰ may bond to each other to form a ring; and
L¹ is a single bond, —O—, —S—, —N(R)— (R is an alkyl group or a substituted or unsubstituted aryl group), an alkylene group or an arylene group.

7. The organic electroluminescent device according to claim 1, wherein the electron-transporting material of the electron-transporting layer is an aromatic compound represented by the following formula (5): 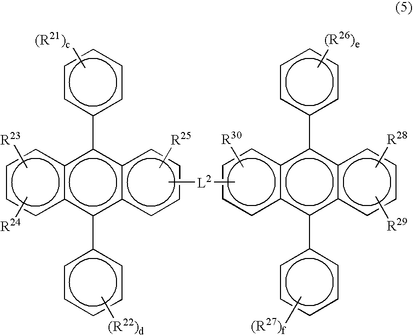
wherein R²¹ to R³⁰ are independently a hydrogen atom, an alkyl group, a cycloalkyl group, an aryl group, an alkoxy group, an aryloxy group, an alkylamino group, an arylamino group or a substituted or unsubstituted heterocyclic group;
c, d, e and f are each an integer of 1 to 5, and when they are 2 or more, R²¹s, R²²s, R²⁶s or R²⁷s may be the same or different and R²¹s, R²²s, R²⁶s or R²⁷s may bond to each other to form a ring;
R² and R²⁴, and R²⁸ and R²⁹ may bond to each other to form a ring; and
L² is a single bond, —O—, —S—, —N(R)— (R is an alkyl group or a substituted or unsubstituted aryl group), an alkylene group, or an arylene group.

8. The organic electroluminescent device according to claim 1, wherein the electron-transporting material of the electron-transporting layer is an aromatic compound represented by the following formula (6):
(A³)q—(X¹)h-(Ar¹¹)i-(Y¹)j—(B¹)k (6)
wherein X¹ is independently a substituted or unsubstituted pyrene residue;
A³ and B¹ are independently a hydrogen atom, a substituted or unsubstituted aromatic hydrocarbon group having 3 to 50 nucleus carbon atoms, a substituted or unsubstituted aromatic heterocyclic group having 1 to 50 nucleus carbon atoms, a substituted or unsubstituted alkyl group or alkylene group having 1 to 50 carbon atoms or a substituted or unsubstituted alkenyl group or alkenylene group having 1 to 50 carbon atoms;
Ar¹¹ is independently a substituted or unsubstituted aromatic hydrocarbon group having 3 to 50 nucleus carbon atoms or a substituted or unsubstituted aromatic heterocyclic group having 1 to 50 nucleus carbon atoms;
Y¹ is independently a substituted or unsubstituted aryl group;
h is an integer of 1 to 3, q and k are each an integer of 0 to 4, j is an integer of 0 to 3, and i is an integer of 1 to 5.

9. The organic electroluminescent device according to claim 1, wherein the electron-transporting material of the electron-transporting layer is an aromatic compound represented by the following formula (7): 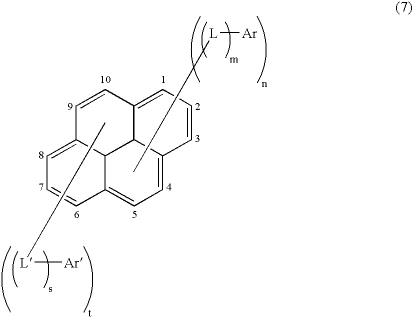
wherein Ar and Ar′ are independently a substituted or unsubstituted aryl group having 6 to 50 nucleus carbon atoms;
L and L′ are independently a substituted or unsubstituted phenylene group, a substituted or unsubstituted naphthalenylene group, a substituted or unsubstituted fluorenylene group or a substituted or unsubstituted dibenzosilolylene group;
m is an integer of 0 to 2, n is an integer of 1 to 4, s is an integer of 0 to 2, t is an integer of 0 to 4, and when m, n, s or t is plural, Ars, Ar's, Ls or L's may be the same or different; and
L or Ar bonds to any position of 1 to 5 of the pyrene, and L′ or Ar′ bonds to any position of 6 to 10 of the pyrene.

10. The organic electroluminescent device according to claim 1, wherein the electron-transporting material of the electron-transporting layer is an aromatic compound represented by the following formula (8): 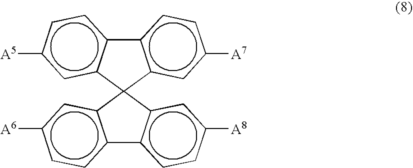
wherein A⁵ to A⁸ are independently a substituted or unsubstituted biphenyl group or a substituted or unsubstituted naphthyl group.

11. The organic electroluminescent device according to claim 1, wherein the electron-transporting material of the electron-transporting layer is an aromatic compound represented by the following formula (9): 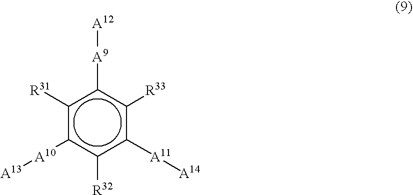
wherein A⁹ to A¹¹ are independently a substituted or unsubstituted arylene group having 6 to 50 nucleus carbon atoms; A¹² to A¹⁴ are independently a hydrogen atom, a substituted or unsubstituted aryl group having 6 to 50 nucleus carbon atoms; R³¹ to R³³ are independently a hydrogen atom, an alkyl group having 1 to 6 carbon atoms, a cycloalkyl group having 3 to 6 carbon atoms, an alkoxyl group having 1 to 6 carbon atoms, an aryloxy group having 5 to 18 carbon atoms, an aralkyloxy group having 7 to 18 carbon atoms, an arylamino group having 5 to 16 carbon atoms, a nitro group, a cyano group, an ester group having 1 to 6 carbon atoms or a halogen atom; and at least one of A⁹ to A¹⁴ is a group having 3 or more condensed aromatic rings.

12. The organic electroluminescent device according to claim 1, wherein the electron-transporting material of the electron-transporting layer is an aromatic compound represented by the following formula (10): 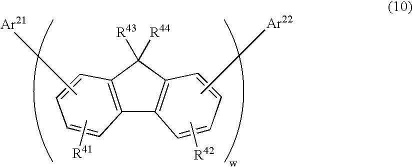
wherein R⁴¹ and R⁴² are a hydrogen atom, a substituted or unsubstituted alkyl group, a substituted or unsubstituted aralkyl group, a substituted or unsubstituted aryl group, a substituted or unsubstituted heterocyclic group, a substituted amino group, a cyano group or a halogen atom; R⁴¹ and R⁴² bonding to different fluorene groups may be the same or different; R⁴¹ and R⁴² bonding to the same fluorene group may be the same or different;
R⁴³ and R⁴⁴ are independently a hydrogen atom, a substituted or unsubstituted alkyl group, a substituted or unsubstituted aralkyl group, a substituted or unsubstituted aryl group or a substituted or unsubstituted heterocyclic group; R⁴³ and R⁴⁴ bonding to different fluorene groups may be the same or different; R⁴³ and R⁴⁴ bonding to the same fluorene group may be the same or different;
Ar²¹ and Ar²² are independently a substituted or unsubstituted condensed polycyclic aryl group having 3 or more benzene rings in total or a substituted or unsubstituted polycyclic heterocyclic group having 3 or more benzene rings and heterocyclic rings in total and bonding to the fluorene group through a carbon atom; Ar²¹ and Ar²² may be the same or different; and
w is an integer of 1 to 10; when w is plural, R⁴¹s, R⁴²s, R⁴³s or R⁴⁴s may be the same or different.

13. The organic electroluminescent device according to claim 1, wherein the compound which contains a nitrogen-containing five-membered heterocyclic structure of the electron-injecting layer is a compound represented by the following formula (12): 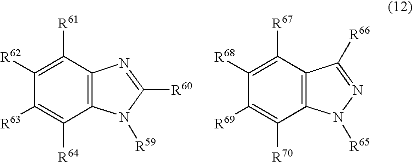
wherein R⁵⁹ to R⁷⁰ are independently a hydrogen atom, a substituted or unsubstituted aryl group having 5 to 60 nucleus atoms, a substituted or unsubstituted heteroaryl group having 5 to 60 nucleus atoms, a substituted or unsubstituted alkyl group having 1 to 50 carbon atoms, a substituted or unsubstituted cycloalkyl group having 3 to 50 carbon atoms, a substituted or unsubstituted aralkyl group having 6 to 50 nucleus atoms, a substituted or unsubstituted alkoxy group having 1 to 50 carbon atoms, a substituted or unsubstituted aryloxy group having 5 to 50 nucleus atoms, a substituted or unsubstituted arylthio group having 5 to 50 nucleus atom, a substituted or unsubstituted alkoxycarbonyl group having 1 to 50 carbon atoms, a substituted or unsubstituted amino group substituted with an aryl group having 5 to 50 nucleus atoms, a halogen atom, a cyano group, a nitro group, a hydroxyl group, or a carboxyl group; adjacent groups of R⁵⁹ to R⁷⁰ may bond to each other to form an aromatic ring; and at least one of R⁵⁹ and R⁷⁰ is a substituent represented by the following formula: 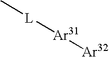
wherein L is a substituted or unsubstituted arylene group having 6 to 60 carbon atoms, a substituted or unsubstituted heteroarylene group having 5 to 60 carbon atoms or a substituted or unsubstituted fluorenylene group;
Ar³¹ is a substituted or unsubstituted arylene group having 6 to 60 carbon atoms, a substituted or unsubstituted pyridinylene group or a substituted or unsubstituted quinolinylene group;
Ar³² is a hydrogen atom, a substituted or unsubstituted aryl group having 5 to 60 nucleus atoms, a substituted or unsubstituted pyridyl group, a substituted or unsubstituted quinolyl group, a substituted or unsubstituted alkyl group having 1 to 50 carbon atoms, a substituted or unsubstituted cycloalkyl group having 3 to 50 carbon atoms, a substituted or unsubstituted aralkyl group having 6 to 50 nucleus atoms, a substituted or unsubstituted alkoxy group having 1 to 50 carbon atoms, a substituted or unsubstituted aryloxy group having 5 to 50 nucleus atoms, a substituted or unsubstituted arylthio group having 5 to 50 nucleus atoms, a substituted or unsubstituted alkoxycarbonyl group having 1 to 50 carbon atoms, an amino group substituted with a substituted or unsubstituted aryl group having 5 to 50 nucleus atoms, a halogen atom, a cyano group, a nitro group, a hydroxyl group or a carboxyl group.

14. The organic electroluminescent device according to claim 1, wherein the compound which contains a nitrogen-containing five-membered heterocyclic structure of the electron-injecting layer is a compound represented by the following formula: 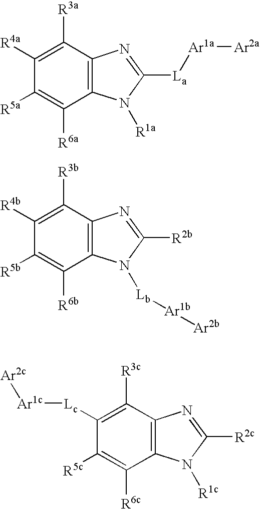
wherein R^{1a} to R^{5c}, Lₐ to L_{c}, and Ar^{1a} to Ar^{2c} are the same as R⁵⁹ to R⁷⁰, L, Ar³¹ and Ar³² in the above formula (12), respectively.
